(19) United States
(12) Patent Application Publication
(10) Pub. No.: US 2005/0187905 A1
(43) Pub. Date: Aug. 25, 2005

(54) Database manipulations using group theory

(76) Inventors: Heidi E. Dixon, Eugene, OR (US); Matthew L. Ginsberg, Eugene, OR (US); David Hofer, Eugene, OR (US); Eugene M. Luks, Eugene, OR (US)

Correspondence Address: FENWICK & WEST LLP, SILICON VALLEY CENTER, 801 CALIFORNIA STREET, MOUNTAIN VIEW, CA, 94041, US

(21) Appl. No.: 10/773,351

(22) Filed: Feb. 5, 2004

(51) Int. Cl. G06F 7/00

(52) U.S. Cl. 707/3

(57) ABSTRACT

Data in a database describe an application domain such as a satisfiability problem. The data are represented in a manner that expresses the structure inherent in the data and one such representation uses group theory and represents the data as one or more “augmented clauses,” where each clause has a pair (c,G) including a database element c and a group G of group elements g acting on it. A query is encoded in a group theory representation and is executed on the group theory representation of the data to identify database elements and associated group elements satisfying the query. If desired, the satisfying database elements are converted from the group theory representation to the native representation of the data.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of contract nos. F30602-00-2-0534 and F33615-02-C-4032, awarded by the Defense Advanced Research Laboratory and the Air Force Research Laboratory.

### CROSS REFERENCE TO RELATED APPLICATION

This application is related to U.S. Pat. No. 6,556,978, which is hereby incorporated herein by reference.

### BACKGROUND OF THE INVENTION

1. Field of the Invention

This invention pertains in general to searching and manipulating database information in order to identify database elements satisfying specified properties. The invention more particularly pertains to manipulating database information to represent and solve satisfiability and other types of logic problems such as those involved in microprocessor verification and testing.

2. Description of the Related Art

Most computer systems that manipulate large amounts of data store the data by using general patterns of which the individual data elements are instances. The last few years have seen extraordinary improvements in the effectiveness of general-purpose algorithms that manipulate these data, as represented by improvements in the performance of Boolean satisfiability engines. These techniques have been applied in a wide range of application domains such as generative planning, circuit layout, and microprocessor verification and testing.

As the application domains become more sophisticated, the amount of information manipulated by these systems grows. In many cases, this information is represented by the set of ground instances of a single universally quantified axiom, but a single axiom such as
∀xyz.[a(x, y) [symbol] b(y,z)→c(x,z)]
has d³ ground instances if d is the size of the domain from which x, y and z are taken. In most cases, the prior art has dealt with the difficulty of managing the large number of ground instances by increasing computer memory and by finding axiomatizations for which ground theories remain manageably sized. In general, memory and these types of axiomatizations are both scarce resources and a more natural solution is desired. There have been some attempts to manipulate quantified axioms directly, but these attempts have been restricted to axioms of a particular form and structure. What is needed is a general approach that is capable of utilizing whatever structure exists in the data describing the application domain in order to minimize the memory and reduce the dependency on axiomatizations.

### BRIEF SUMMARY OF THE INVENTION

The above need is met by using group theory to represent the data describing the application domain. This representation expresses the structure inherent in the data. Moreover, group theory techniques are used to solve problems based on the data in a manner that uses computational resources efficiently.

In one embodiment, the data describing the application domain are represented as sets of database entries, where each set (c,G) includes a database element c and a group G of elements g that can act on the database element c to produce a new database element (which is typically denoted as g(c)). The present invention uses computational techniques to perform database manipulations (such as a query for a database entry satisfying certain syntactic properties) on the data in the group theory representation, rather than on the data in the non-group theory representation (referred to herein as the data's “native representation”).

A database query asks whether the data describing the application domain have one or more specified properties, seeks to identify any input data having the properties and, in some cases, constructs new database elements. In one embodiment, a query specifies a Boolean satisfiability problem and seeks to determine whether any solutions or partial solutions to the problem exist (and to identify the solutions or partial solutions), whether any element of the problem is unsatisfiable given known or hypothesized problem features, or whether any single element of the problem can be used to derive new features from existing ones. The input query is typically directed toward the native representation of the data and is therefore converted into an equivalent query on the data in the group theory representation.

The converted query is executed on the data in the group theory representation. In one embodiment, query execution produces a collection of zero or more group elements g that can act on database elements c associated to the group elements and satisfy the properties specified by the input query. If necessary or desired, the results of the query are converted from the group theory representation into the native representation of the data for the application domain.

### BRIEF DESCRIPTION OF THE DRAWINGS

FIG. 1 is a high-level block diagram of a computer system for storing and manipulating data using group theory according to an embodiment of the present invention;

FIG. 2 is a high-level block diagram of program modules for storing and manipulating data using group theory according to one embodiment of the present invention;

FIG. 3 is a flowchart illustrating steps for performing database manipulations using group theory according to an embodiment of present invention

FIG. 4 is a flowchart illustrating the “formulate query” and “execute query” steps of FIG. 3 according to an embodiment of the present invention wherein multiple low-level queries are generated from an initial query;

FIG. 5 is a flowchart illustrating a more detailed view of the “formulate query” and “execute query” steps of FIG. 3; and

FIGS. 6-16 illustrate diagrams representing examples of search spaces utilized by an embodiment of the present invention.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

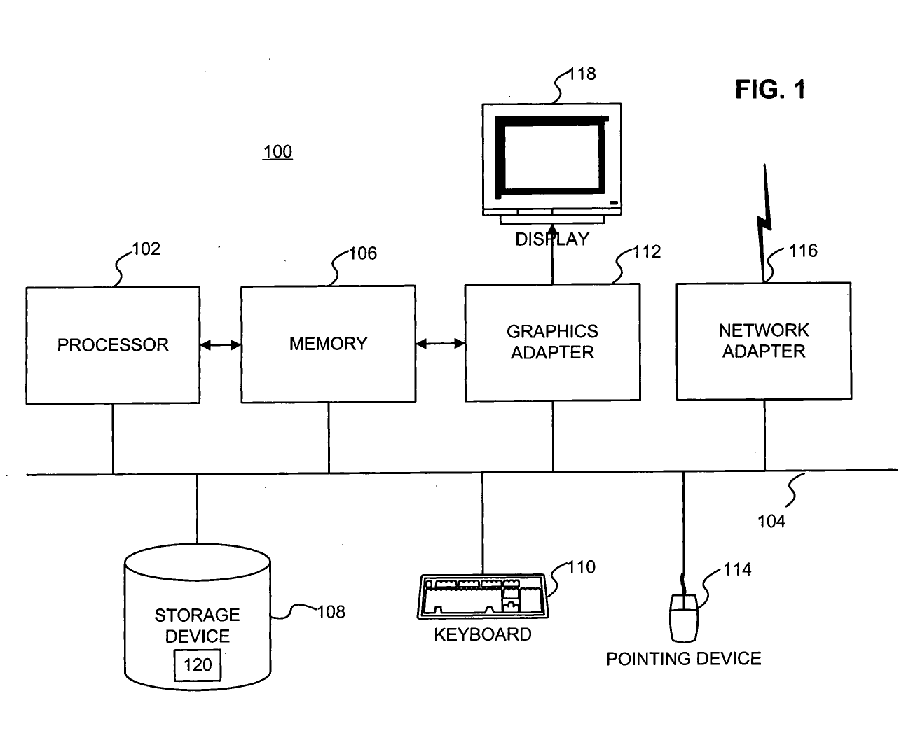

FIG. 1 is a high-level block diagram of a computer system 100 for storing and manipulating database information using group theory according to an embodiment of the present invention. Illustrated are at least one processor 102 coupled to a bus 104. Also coupled to the bus 104 are a memory 106, a storage device 108, a keyboard 110, a graphics adapter 112, a pointing device 114, and a network adapter 116. A display 118 is coupled to the graphics adapter 112. Some embodiments of the computer system 100 have different and/or additional components than the ones described herein.

The processor 102 may be any general-purpose processor such as an INTEL x86 compatible-, POWERPC compatible-, or SUN MICROSYSTEMS SPARC compatible-central processing unit (CPU). The storage device 108 may be any device capable of holding large amounts of data, like a hard drive, compact disk read-only memory (CD-ROM), DVD, etc. The memory 106 holds instructions and data used by the processor 102. The pointing device 114 may be a mouse, track ball, light pen, touch-sensitive display, or other type of pointing device and is used in combination with the keyboard 110 to input data into the computer system 100. The network adapter 116 optionally couples the computer system 100 to a local or wide area network.

Program modules 120 for storing and manipulating database information using group theory according to an embodiment of the present invention are stored on the storage device 108, from where they are loaded into the memory 106 and executed by the processor 102. Alternatively, hardware or software modules may be stored elsewhere within the computer system 100 or on one or more other computer systems connected to the computer system 100 via a network or other means. As used herein, the term “module” refers to computer program instructions, embodied in software and/or hardware, for performing the function attributed to the module. In one embodiment of the present invention, the operation of the computer system 100 is controlled by the LINUX operating system, although other operating systems can be used as well.

An embodiment of the present invention receives data describing objects or activities external to the computer system 100 and formulates the data in a representation that expresses structure inherent in the data. In a preferred embodiment, the representation utilizes a branch of mathematics referred to as “Group Theory” and the data are represented as sets of database entries, where each set (c,G) includes a database element c and a group G of elements g that can act on the database element. In one embodiment, the group elements g are permutations acting on the associated database element c.

The present invention uses computational techniques to perform database manipulations (such as a query for a database entry satisfying certain syntactic properties) on the data in the group theory representation, rather than on the data in the non-group theory representation (referred to herein as the data's “native representation”). These database manipulations are more efficient than equivalent manipulations on native or other representations of the data.

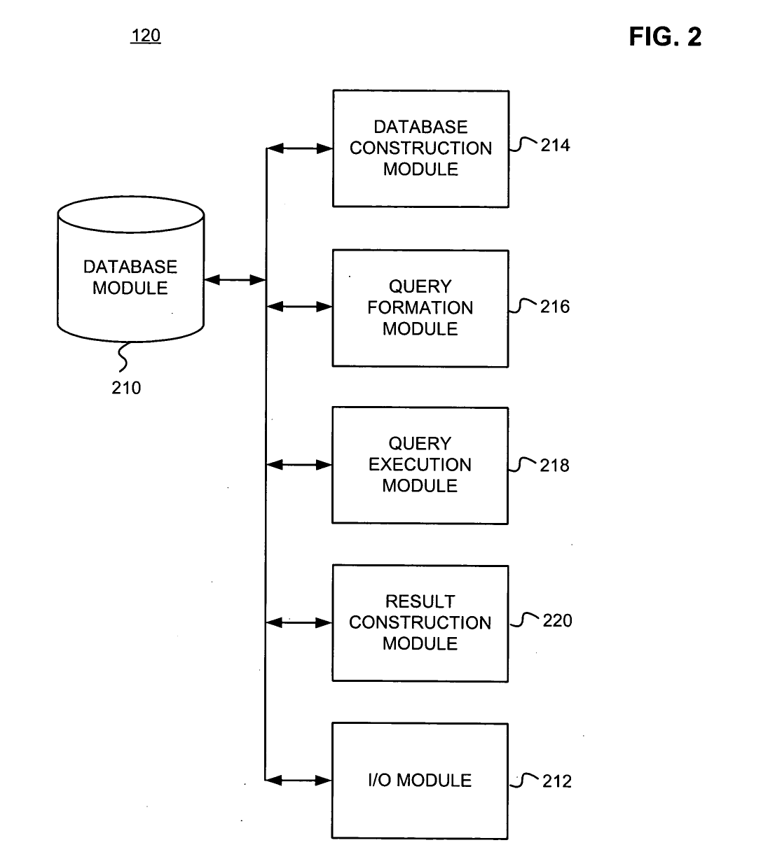

FIG. 2 is a high-level block diagram of program modules 120 for storing and manipulating database information using group theory according to one embodiment of the present invention. Those of skill in the art will recognize that embodiments of the present invention can include different modules in addition to, or instead of, the ones illustrated herein. Moreover, the modules can provide other functionalities in addition to, or instead of, the ones described herein. Similarly, the functionalities can be distributed among the modules in a manner different than described herein.

A database module 210 (often referred to as the “database”) stores data utilized by the present invention. As used herein, the term “database” refers to a collection of data and does not imply any particular arrangement of the data beyond that described herein. The data are within one or more application domains. The data within each application domain represent and/or describe one or more objects or activities external to the computer system, including prospective and/or theoretical instances of the objects and activities, relevant to the domain. For example, data within a given application domain can represent a design for a microprocessor or other digital logic device. Likewise, data within a given application domain can represent a series of actions that must or can be performed on a construction project for building a complex object such as a ship or bridge. In another application domain, the data can represent an employee directory containing names, telephone numbers, and reporting paths. Those of skill in the art will recognize that the data can belong to a wide variety of application domains beyond those described here.

The data within an application domain have inherent structure due to the nature of the domain. This structure can be explicit and/or implicit. The data within each application domain are preferably represented using group theory in order to express this structure. The group theory representation is contrasted with the data's non-group theory, or native, representation where the structure is not necessarily expressed. For example, if the application domain describes an employee directory, the data in the native representation include a listing of names and reporting paths or perhaps a machine-readable (but not group theory-based) equivalent of the listing and paths. The data in the group theory representation, on the other hand, are represented as sets of database elements c and groups G of group elements g, i.e. (c,G). Each element g of the group G “acts” on its associated database element c (the action is typically denoted as g(c)) to produce a new database element.

An input/output (I/O) module 212 controls the flow of data into, and out of, the computer system 100. In general, the I/O module 212 receives “input data,” which are data within an application domain and describing one or more objects or activities external to the computer system, including prospective and/or theoretical instances of the objects and/or activities, and “input queries,” which are queries asking whether the input data have certain properties. The input data received by the I/O module 212 can be encoded in either a group theory representation or the data's native representation.

The input data and/or input queries are provided to the computer system 100 by, for example, transmission over a computer network, loading from a computer-readable medium, and/or via the keyboard 110, pointing device 114, or other interface device. The input data are preferably stored in the database 210. The input queries are stored in the database 210 or elsewhere within the computer system 100.

In general, the input data are generated by creating electronic representations of objects and/or activities in the pertinent application domains, such as representations of the aforementioned digital logic device, construction project, or employee directory, and providing the electronic representations to the computer system 100. In one embodiment, the input data are generated by taking measurements of physical or prospective physical objects. The input data can be provided to the computer system 100 in their native representation or after the data are converted from their native representation to the group theory representation.

An input query asks whether the input data have given properties and seeks to identify the input data having the properties. For example, a query can ask whether a digital logic device behaves in a specified manner, whether an optimal set of steps for a construction project exist, etc. In one embodiment, a query specifies a Boolean satisfiability problem and seeks to determine whether any solutions or partial solutions to the problem exist (and to identify the solutions or partial solutions), whether any element of the problem is unsatisfiable given known or hypothesized problem features, or whether any single element of the problem can be used to derive new features from existing ones. A query can also cause new database elements to be added in response to results of a query. For example, a query can save its results in the database 210 in a group theory representation for use by subsequent queries.

The data flowing out of the computer system 100 are referred to herein as “output data” and represent a result of the operation of an input query on the input data as achieved through one or more database manipulations using group theory. The output data represent a concrete, tangible, and useful result of the database manipulations and can include data resulting from physical transformations of the input data. For example, the output data can represent a result of a verification and test procedure indicating whether a digital logic device contains any logic errors. Similarly, the output data can represent a result of a process that determines an optimal ordered sequence of steps for a construction project or other multi-step task. A computer system or human being can use the output data to redesign the digital logic device to correct any errors, to perform the steps of the construction project, etc. The computer system 100 outputs the output data by, for example, transmitting the data over a computer network, loading the data onto a computer-readable medium, displaying the data on a monitor, etc.

A database construction module 214 receives input data within an application domain from the I/O module 212, converts the data from their native representation into the group theory representation (if necessary), and stores the data in the group theory representation in the database 210. In one embodiment, the database construction module 214 converts the data from their native representation to the group theory representation by encoding the input data as one or more augmented clauses, where each clause has a pair (c,G) including a database element c and a group G of elements g acting on it, so that the augmented clause is equivalent to the conjunction of the results of operating on c with the elements of G. This encoding expresses the structure inherent in the input data.

A query formulation module 216 receives the input query from the I/O module 212. The input query is typically directed toward the native representation of the input data. The query formulation module 216 therefore converts the input query into one or more equivalent queries on the input data in the group theory representation. In general, a query specifies a search for database elements satisfying a property P. The query formulation module 216 converts this query into a search for a pair (g,c) where g is a group element and c is a database element, such that g(c) satisfies property P.

In one embodiment, the input query is a “high-level” query. A high-level query is a general question about the input data. Examples of high-level queries are “are the data consistent?” and “does the logic device described by the data have errors?” The answer to a high-level query is not generally a database element, but rather is information derived from the database elements. For example, the answer can be a description of an error in a digital logic device or a report that the device does not have any errors.

In one embodiment, the query formulation module 216 converts the high-level query directly into a group theory based representation. In another embodiment, the query formulation module 216 converts the high-level query into multiple “low-level” queries. A low-level query corresponds to a search for a database element satisfying a particular property, such as “is there a single element of the data in the application domain that is unsatisfiable given the assignments made so far?” The query formulation module 216 converts each of these low-level queries into a group theory representation.

In another embodiment, the input query received by the query formulation module 216 is a low-level query. The low-level query can be derived from a high-level query by an entity external to the module 216. Alternatively, the low-level query can be the entire query desired to be executed on the input data. In either case, the query formulation module 216 converts the low-level query into one or more queries in the group theory representation.

A query execution module 218 receives the one or more converted queries from the query formulation module 216 and executes the queries on the data in the group theory representation of the input data in the database 210. The query execution module 218 preferably uses techniques drawn from computational group theory in order to execute the queries efficiently. The result of a query is a set of zero or more pairs (g,c) where g is a group element and c is a database element, where each g(c) satisfies the property P specified by the query. In one embodiment, the set of answers to the query form a subgroup. In this case, the result of the query can be represented using a compact representation of the subgroup where a small number of group elements h₁ . . . hₙ are described explicitly and the other elements of the subgroup can then be computed by combining h₁ . . . hₙ.

A result construction module 220 receives the results of the one or more query executions from the query execution module 218 and converts the results from the group theory representation to the native representation of the data. Depending upon the application domain, the result produced by the result construction module 220 can be a result of a test on a digital logic device, a sequence of steps for a construction project, etc. The native representation of the query results is received by the I/O module 212, which outputs it as the output data.

In the simple case where a query executed by the query execution module 218 produces a set of pairs (g,c) where g is a group element and c is a database element, such that each g(c) satisfies property P, the result construction module 220 generates g(c) to reconstruct the result of the original query in terms familiar to the native representation of the input data. In a more complex case where the query execution module 218 executes multiple queries and generates multiple results in response to an input query, one embodiment of the result construction module 220 combines the results into a collective result answering the input query. For example, a high-level query can lead to multiple low-level queries and corresponding results. In this case, an embodiment of the result construction module 220 analyzes the results of the low-level queries to generate an answer to the high-level query in terms familiar to the native representation of the input data. In one embodiment, the result construction module 220 constructs answers to both high and low-level queries in terms familiar to the native representation of the input data. This latter embodiment can be used, for example, when the results of the low-level queries allow one to understand the answer to the high-level query.

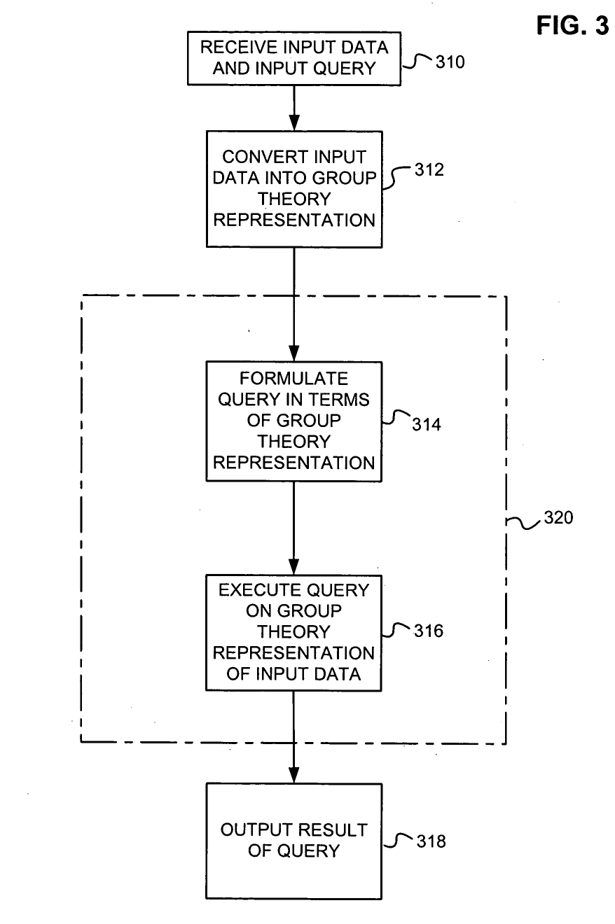

FIG. 3 is a flowchart illustrating steps for performing database manipulations using group theory according to an embodiment of present invention. Those of skill in the art will recognize that embodiments of the present invention can have additional and/or other steps than those described herein. In addition, the steps can be performed in different orders. Moreover, depending upon the embodiment, the functionalities described herein as being within certain steps can be performed within other steps. In one embodiment, the steps described herein are performed by the modules illustrated in FIG. 2. However, in alternative embodiments, some or all of the steps are performed by other entities.

Initially, the input data and input query are received 310. For example, the input data can describe a digital logic device and the input query can ask whether the device behaves in a specified manner. The input data need not be received contemporaneously with the input query, and the input data and input query are not necessarily received in a particular order. The input data either are already in the group theory representation, or are converted 312 from their native representation into the group theory representation. In addition, the input query is formulated 314 in terms of the group theory representation. The group theory representation of the query is executed 316 on the group theory representation of the input data to produce a result. The result is then output 318.

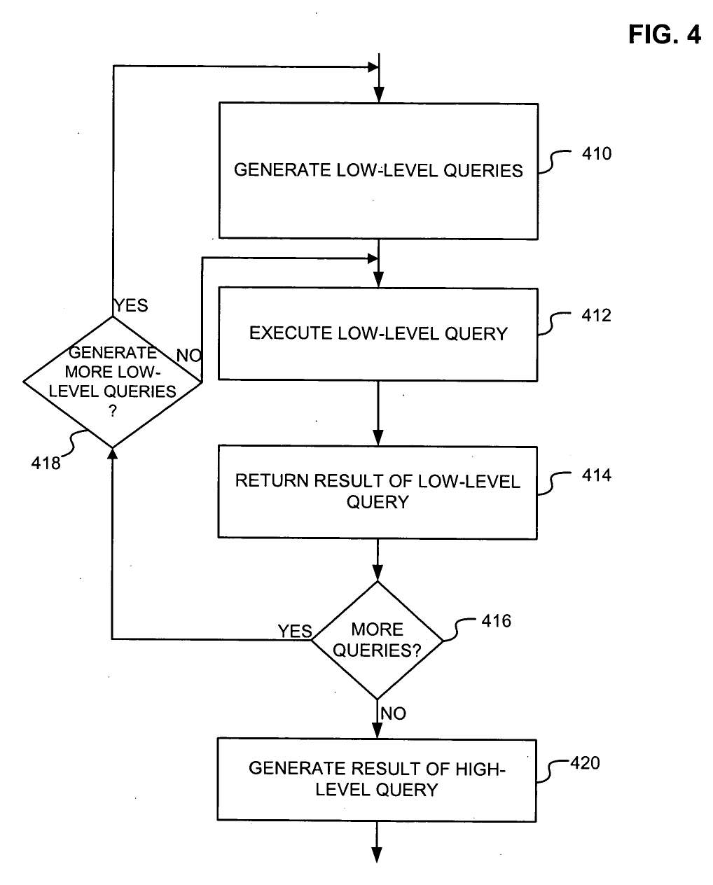

FIG. 4 is a flowchart illustrating a view of the “formulate query” 314 and “execute query” 316 steps of FIG. 3 according to an embodiment where a high-level query is reduced into multiple low-level queries. These steps are identified by a broken line 320 in FIG. 3. Initially, the low-level queries in the group theory representation are generated 410 from the high-level query (or from another low-level query as described below). A low-level query is executed 412 on the group theory representation of the input data to produce a result. This result is returned 414 to the entity performing the method and can be used, for example, to create new database elements and/or modify existing elements. If 416 there are more low-level queries, the method returns to step 412 and continues to execute. In one embodiment, the results of one or more of the low-level queries are used 418 to generate 410 additional low-level queries and the method therefore returns to step 410. Once the low-level queries have executed, the method uses the results of the low-level queries to generate 420 a result of the high-level query. This result is then output 318.

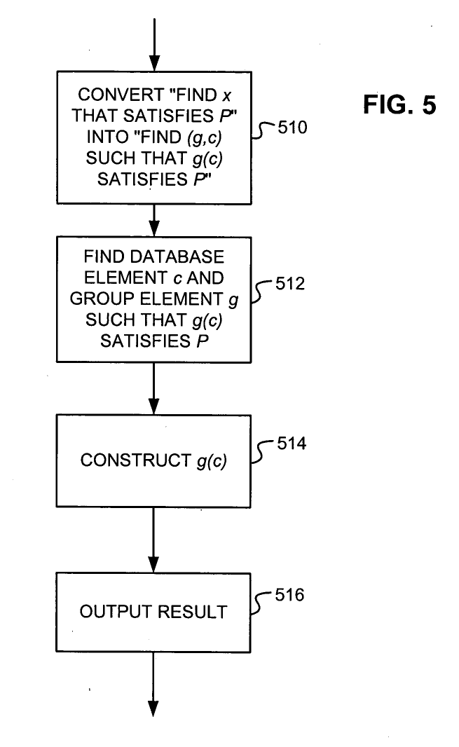

FIG. 5 is a flowchart illustrating a detailed view of the “formulate query” 314 and “execute query” 316 steps of FIG. 3, which can correspond to the “execute low-level query” 412 step of FIG. 4 in certain embodiments. The native representation of the input query (or low-level queries generated from a high-level query) are generally of the type “find element x that satisfies property P.” This query is converted 510 into the equivalent group theory query, which is “find database element c and element g of a group G, such that g(c) satisfies property P.” Next, the formulated query is executed 512 on the input data in the group theory representation to identify any database elements c and group elements g where g(c) satisfies P. The zero or more pairs (g,c) that are identified in response to the query are converted from the group theory representation into the native representation of the input data. This conversion is performed by using the group element g, and the database element c, to construct 514 g(c). The resulting value 516 is returned as the result of the query.

The following description includes two sections describing an embodiment of the present invention. The first section describes the theory of the present invention. The second section describes an implementation of one embodiment. Those of skill in the art will recognize that embodiments of the present invention can differ from the ones described herein.

### THEORY

1 Introduction

This document describes ZAP, a satisfiability engine that substantially generalizes existing tools while retaining the performance characteristics of existing high-performance solvers such as ZCHAFF. Those of skill in the art will recognize that the concepts described herein can be utilized for problem domains other than satisfiability. The following table describes a variety of existing computational improvements to the Davis-Putnam-Logemann-Loveland (DPLL) inference procedure:

| | rep'l | p-simulation | | | |
|---|---|---|---|---|---|
| | efficiency | hierarchy | inference | propagation | learning |
| SAT | 1 | EEE | resolution | watched literals | relevance |
| cardinality | exp | P?E | not unique | watched literals | relevance |
| pseudo- | exp | P?E | unique | watched literals | +strengthening |
| Boolean | | | | | |
| symmetry | 1 | EEE* | not in P | same as SAT | same as SAT |
| QPROP | exp | ??? | in P using reasons | exp improvement | +first-order |

The lines of the table correspond to observations regarding existing representations used in satisfiability research, as reflected in the labels in the first column:
1. SAT refers to conventional Boolean satisfiability work, representing information as conjunctions of disjunctions of literals (CNF).
2. cardinality refers to the use of “counting” constraints; if we think of a conventional disjunction of literals [symbol] ᵢlᵢ as

$${\sum }_{i} {l}_{i} \geq 1$$
then a cardinality constraint is one of the form

$${\sum }_{i} {l}_{i} \geq k$$
for a positive integer k.
3. pseudo-Boolean constraints extend cardinality constraints by allowing the literals in question to be weighted:

$${\sum }_{i} {w}_{i} {l}_{i} \geq k$$
Each wᵢ is a positive integer giving the weight to be assigned to the associated literal.
4. symmetry involves the introduction of techniques that are designed to explicitly exploit local or global symmetries in the problem being solved.
5. QPROP deals with universally quantified formulae where all of the quantifications are over finite domains of known size.

The remaining columns in the table measure the performance of the various systems against a variety of metrics:
1. Representational efficiency measures the extent to which a single axiom in a proposed framework can replace many in CNF. For cardinality, pseudo-Boolean and quantified languages, it is possible that exponential savings are achieved. We argue that such savings are possible but relatively unlikely for cardinality and pseudo-Boolean encodings but are relatively likely for QPROP.
2. p-simulation hierarchy gives the minimum proof length for the representation on three classes of problems: the pigeonhole problem, parity problems and clique coloring problems. An E indicates exponential proof length; P indicates polynomial length. While symmetry-exploitation techniques can provide polynomial-length proofs in certain instances, the method is so brittle against changes in the axiomatization that we do not regard this as a polynomial approach in general.
3. Inference indicates the extent to which resolution can be lifted to a broader setting. This is straightforward in the pseudo-Boolean case; cardinality constraints have the problem that the most natural resolvent of two cardinality constraints may not be one. Systems that exploit local symmetries must search for such symmetries at each inference step, a problem that is not believed to be in P. Provided that reasons are maintained, inference remains well defined for quantified axioms, requiring only the introduction of a (linear complexity) unification step.
4. Propagation describes the techniques available to draw conclusions from an existing partial assignment of values to variables. For all of the systems except QPROP, Zhang and Stickel's watched literals idea is the most efficient mechanism known. This approach cannot be lifted to QPROP, but a somewhat simpler method can be lifted and average-case exponential savings obtained as a result.
5. Learning reflects the techniques available to save conclusions as the inference proceeds. In general, relevance-bounded learning is the most effective technique known here. It can be augmented with strengthening in the pseudo-Boolean case and with first-order reasoning if quantified formulae are present.

An embodiment of the present invention, referred to herein as “ZAP” is represented in the table as:

| | | | | | |
|---|---|---|---|---|---|
| ZAP | exp | PPP | in P | watched literals, | +first-order |
| | | p-simulates | using | exp improvement | +parity |
| | | extended res'n | reasons | | +others |

Some comments are in order:
Unlike cardinality and pseudo-Boolean methods, which seem unlikely to achieve exponential reductions in problem size in practice, and QPROP, which seems likely to achieve such reductions, ZAP is guaranteed to replace a set of n axioms for which the requisite structure is present with a single axiom of size log(n) (Proposition 3.6).
In addition to providing robust, polynomially sized proofs of the three “benchmark” proof complexity problems cited previously, ZAP can p-simulate extended resolution, so that if P is a proof in extended resolution, there is a proof P′ of size polynomial in P in ZAP (Theorem 5.12).
The fundamental inference step in ZAP is in NP with respect to the ZAP representation, and therefore has worst case complexity exponential in the representation size (i.e., polynomial in the number of Boolean axioms being resolved). The average case complexity appears to be low-order polynomial in the size of the ZAP representation (i.e., polynomial in the logarithm of the number of Boolean axioms being resolved).
ZAP obtains the savings attributable to subsearch in the QPROP case while casting them in a general setting that is equivalent to watched literals in the Boolean case. This particular observation is dependent on a variety of results from computational group theory.
In addition to learning the Boolean consequences of resolution, ZAP continues to support relevance-based learning schemes while also allowing the derivation of first-order consequences, conclusions based on parity arguments, and combinations thereof.

The next section summarizes both the DPLL algorithm and the modifications that embody recent progress, casting DPLL into the precise form that is both needed in ZAP and that seems to best capture the architecture of modern systems such as ZCHAFF.

In a later section, we present the insights underlying ZAP. Beginning with a handful of examples, we see that the structure exploited in earlier examples corresponds to the existence of particular subgroups of the group of permutations of the literals in the problem; this corresponds to the representational efficiency column of our table. The “inference” section describes resolution in this broader setting, and the p-simulation hierarchy section presents a variety of examples of these ideas at work, showing that the pigeonhole problem, clique-coloring problems, and Tseitin's parity examples all admit short proofs in the new framework. We also show that our methods p-simulate extended resolution. The learning section recasts the DPLL algorithm in the new terms and discusses the continued applicability of relevance in our setting.

2 Boolean Satisfiability Engines

We begin here by being precise about Davis-Putnam-Logemann-Loveland extensions that deal with learning. We give a description of the DPLL algorithm in a learning/reason-maintenance setting, and prove that it is possible to implement these ideas while retaining the soundness and completeness of the algorithm but using an amount of memory that grows polynomially with problem size.

Procedure 2.1 (Davis-Putnam-Logemann-Loveland) Given a SAT problem C and a partial assignment P of values to variables, to compute DPLL(C,P):

| | |
|---|---|
| 1 | P [symbol] UNIT-PROPAGATE(P) |
| 2 | if P = FAILURE |
| 3 | then return FAILURE |
| 4 | if P is a solution to C |
| 5 | then return SUCCESS |
| 6 | l [symbol] a literal not assigned a value by P |
| 7 | if DPLL(C, P ∪ {l = true}) = SUCCESS |
| 8 | then return SUCCESS |
| 9 | else return DPLL(C, P ∪ {l = false}) |

Variables are assigned values via branching and unit propagation. In unit propagation (described below), the existing partial assignment is propagated to new variables where possible. If unit propagation terminates without reaching a contradiction or finding a solution, then a branch variable is selected and assigned a value, and the procedure recurs. Here is a formal description of unit propagation:

Procedure 2.2 (Unit propagation) To compute UNIT-PROPAGATE(P):

| | |
|---|---|
| 1 | while there is a currently unsatisfied clause c ∈ C that contains at |
| | most one literal unassigned a value by P |
| 2 | do if every variable in c is assigned a value by P |
| 3 | then return FAILURE |
| 4 | else v [symbol] the variable in c unassigned by P |
| 5 | P [symbol] P ∪ {v = V : V is selected so that |
| | c is satisfied} |
| 6 | return P |

We can rewrite this somewhat more formally using the following definition:

Definition 2.3 Let [symbol] ᵢlᵢ be a clause, which we will denote by c. Now suppose that P is a partial assignment of values to variables. We will say that the possible value of c under P is given by
poss(c,P)=|{i|lᵢ∉P}|−1
If no ambiguity is possible, we will write simply poss(c) instead of poss(c, P). In other words, poss(c) is the number of literals that are either already satisfied or not valued by P, reduced by one (since the clause requires one literal true be true).

If S is a set of clauses, we will write possₙ(S,P) for the subset of cεS for which poss(c,P)≦n and poss_{>n}(S,P) for the subset of learned clauses cεS for which poss(c,P)>n.

The above definition can be extended easily to deal with pseudo-Boolean instead of Boolean constraints, although that extension will not be our focus here.

Procedure 2.4 (Unit propagation) To compute UNIT-PROPAGATE(P):

| | |
|---|---|
| 1 | while poss₀(C, P) ≠ Ø |
| 2 | do if poss₋₁(C, P) ≠ Ø |
| 3 | then return FAILURE |
| 4 | else c [symbol] an element of poss₀(C, P) |
| 5 | v [symbol] the variable in c unassigned by P |
| 6 | P [symbol] P ∪ {v = V : V is selected so that |
| | c is satisfied} |
| 7 | return P |

As with Definition 2.3, the above description can be extended easily to deal with pseudo-Boolean or other clause types.

Procedures 2.4 and 2.1 are generally extended to include some sort of learning. For our ideas to be consistent with this, we introduce:

Definition 2.5 A partial assignment is an ordered sequence [symbol]
l₁, . . . ,lₙ [symbol]
of literals. An annotated partial assignment is an ordered sequence [symbol]
(l₁c₁), . . . ,(lₙcₙ) [symbol]
of literals and clauses, where cᵢ is the reason for literal lᵢ and either cᵢ=true (indicating the lᵢ was a branch point) or cᵢ is a clause such that:
1. lᵢ is a literal in cᵢ, and
2. poss(cᵢ, [symbol] l₁, . . . , lᵢ₋₁ [symbol] )=0
   An annotated partial assignment will be called sound with respect to a set of constraints C if C|=cᵢ for each reason cᵢ.

The point of the definition is that the reasons have the property that after the literals l₁, . . . , lᵢ₋₁ are all set to true, it is possible to conclude lᵢ from cᵢ by unit propagation.

Definition 2.6 If c₁ and c₂ are reasons, we will define the result of resolving c₁ and c₂ to be:

$$resolve ( {c}_{1} , {c}_{2} ) = \{ \begin{matrix}{c}_{2} , & if {c}_{1} = true ; \\ {c}_{1} , & if {c}_{2} = true ; \\ the conventional resolvent of {c}_{1} and {c}_{2} , & otherwise .\end{matrix}$$

We can now rewrite the unit propagation procedure as follows:

Procedure 2.7 (Unit propagation) To compute UNIT-PROPAGATE(P) for an annotated partial assignment P:

| | |
|---|---|
| 1 | while poss₀(C, P) ≠ Ø |
| 2 | do if poss₋₁(C, P) ≠ Ø |
| 3 | then c [symbol] an element of poss₋₁(C, P) |
| 4 | lᵢ [symbol] the literal in c with the highest index in P |
| 5 | return <true, resolve(c, cᵢ)> |
| 6 | else c [symbol] an element of poss₀(C, P) |
| 7 | l [symbol] the variable in c unassigned by P |
| 8 | P [symbol] P ∪ (l, c) |
| 9 | return <false, P> |

The above procedure returns a pair of values. The first indicates whether a contradiction has been found. If so, the second value is the reason for the failure, an unsatisfiable consequence of the clausal database C. If no contradiction is found, the second value is a suitably modified partial assignment. Procedure 2.7 has also been modified to work with annotated partial assignments, and to annotate the new choices that are made when P is extended.

Proposition 2.8 Suppose that C is a Boolean satisfiability problem, and P is a sound annotated partial assignment. Then:
1. If unit-propagate(P)=(false, P′), then P′ is a sound extension of P, and
2. If unit-propagate (P)= [symbol] true, c [symbol] , then C|=c and c is falsified by the assignments in P.

When the unit propagation procedure “fails” and returns [symbol] true, c [symbol] for a new nogood C, there are a variety of choices that must be made by the overall search algorithm. The new clause can be added to the existing collection of axioms to be solved, perhaps simultaneously deleting other clauses in order to ensure that the clausal database remains manageably sized. It is also necessary to backtrack at least to a point where c becomes satisfiable. Some systems such as ZCHAFF backtrack further to the point where c is unit. Here is a suitable modification of Procedure 2.1:

Procedure 2.9 Given a SAT problem C and an annotated partial assignment P, to compute DPLL(C, P):

| | |
|---|---|
| 1 | if P is a solution to C |
| 2 | then return P |
| 3 | <x, y> [symbol] UNIT-PROPAGATE(P) |
| 4 | if x = true |
| 5 | then c [symbol] y |
| 6 | if c is empty |
| 7 | then return FAILURE |
| 8 | else C [symbol] C ∪ {c} |
| 9 | delete clauses from C as necessary to |
| | keep C small |
| 10 | backtrack at least to the point that c is |
| | satisfiable |
| 11 | return DPLL(C, P) |
| 12 | else P [symbol] y |
| 13 | if P is a solution to C |
| 14 | then return P |
| 15 | else l [symbol] a literal not assigned a value by P |
| 16 | return DPLL(C, <P, (l, true)>) |

This procedure is substantially modified from Procedure 2.1, so let us go through it.

The fundamental difference is that both unit propagation and the DPLL procedure can only fail if a contradiction (an empty clause c) is derived. In all other cases, progress is made by augmenting the set of constraints to include at least one new constraint that eliminates the current partial solution. Instead of simply resetting the branch literal l to take the opposite value as in the original procedure 2.1, a new clause is learned and added to the problem, which will cause either l or some previous variable to take a new value.

The above description is ambiguous about a variety of points. We do not specify how the branch literal is chosen, the precise point to backtrack to, or the scheme by which clauses are removed from C. The first two of these are of little concern to us; ZAP makes the same choices here that ZCHAFF does and implementing these choices is straightforward. Selecting clauses for removal involves a search through the database for clauses that have become irrelevant or meet some other condition, and the computational implications of this “subsearch” problem need to be considered as the algorithm evolves.

It will be useful for us to make this explicit, so let us suppose that we have some relevance bound k. The above procedure now becomes:

Procedure 2.10 (Relevance-bound reasoning, RBL) Given a SAT problem C and an annotated partial assignment P, to compute RBL(C,P):

| | |
|---|---|
| 1 | if P is a solution to C |
| 2 | then return P |
| 3 | <x, y> [symbol] UNIT-PROPAGATE(P) |
| 4 | if x = true |
| 5 | then c [symbol] y |
| 6 | if c is empty |
| 7 | then return FAILURE |
| 8 | else remove successive elements from P so that |
| | c is satisfiable |
| 9 | C [symbol] C ∪ {c} - poss_{>k}(C, P) |
| 10 | return RBL(C, P) |
| 11 | else P [symbol] y |
| 12 | if P is a solution to C |
| 13 | then return P |
| 14 | else l [symbol] a literal not assigned a value by P |
| 15 | return RBL(C, <P, (l, true)>) |

Note that the clauses deleted because they belong to poss_{>k}(C,P) are only learned irrelevant clauses (see Definition 2.3); it is inappropriate to remove clauses that are part of the original problem specification.

Theorem 2.11 RBL is sound and complete, and uses an amount of memory polynomial in the size of C (although exponential in the relevance bound k).

3 Axiom Structure as a Group

3.1 Examples of Structure

While we use the implementation details embodied in Procedures 2.10 and 2.7 to implement our ideas, the procedures themselves inherit certain weaknesses of DPLL as originally described. Two weaknesses that we address are:
1. The appearance of poss₀(C, P) in the inner unit propagation loop of the procedure requires an examination of a significant subset of the clausal database at each inference step, and
2. Both DPLL and RBL are fundamentally resolution-based methods; there are known problem classes that are exponentially difficult for resolution-based methods but which are easy if the language in use is extended to include either cardinality or parity constraints.
   Let us consider each of these issues in turn.
   3.1.1 Subsearch

The set of axioms that need to be investigated in the DPLL inner loop often has structure that can be exploited to speed the examination process. If a ground axiomatization is replaced with a lifted one, the search for axioms with specific syntactic properties is NP-complete in the number of variables in the lifted axiom, and is called subsearch for that reason.

In many cases, search techniques can be applied to the subsearch problem. As an example, suppose that we are looking for unit instances of the lifted axiom
a(x,y) [symbol] b(y,z) [symbol] c(x,z) (1)
where each variable is taken from a domain of size d, so that (1) corresponds to d³ ground axioms. If a(x,y) is true for all x and y (which we can surely conclude in time o(d²) or less), then we can conclude without further work that (1) has no unit instances. If a(x, y) is true except for a single (x,y) pair, then we need only examine the d possible values of z for unit instances, reducing our total work from d³ to d²+d.

It will be useful in what follows to make this example still more specific, so let us assume that x, y and z are all chosen from a two element domain {A, B}. The single lifted axiom (1) now corresponds to the set of ground instances:

$$a ( A , A ) ⩔ b ( A , A ) ⩔ c ( A , A )$$

$$a ( A , A ) ⩔ b ( A , B ) ⩔ c ( A , B )$$

$$a ( A , B ) ⩔ b ( B , A ) ⩔ c ( A , A )$$

$$a ( A , B ) ⩔ b ( B , B ) ⩔ c ( A , B )$$

$$a ( B , A ) ⩔ b ( A , A ) ⩔ c ( B , A )$$

$$a ( B , A ) ⩔ b ( A , B ) ⩔ c ( B , B )$$

$$a ( B , B ) ⩔ b ( B , A ) ⩔ c ( B , A )$$

$$a ( B , B ) ⩔ b ( B , B ) ⩔ c ( B , B )$$

If we introduce ground literals l₁, l₂, l₃, l₄ for the instances of a(x,y) and so on, we get:

$${l}_{1} ⋁ {l}_{5} ⋁ {l}_{9} \\ {l}_{1} ⋁ {l}_{6} ⋁ {l}_{10} \\ {l}_{2} ⋁ {l}_{7} ⋁ {l}_{9} \\ {l}_{2} ⋁ {l}_{8} ⋁ {l}_{10} \\ {l}_{3} ⋁ {l}_{5} ⋁ {l}_{11} \\ {l}_{3} ⋁ {l}_{6} ⋁ {l}_{12} \\ {l}_{4} ⋁ {l}_{7} ⋁ {l}_{11} \\ {l}_{4} ⋁ {l}_{8} ⋁ {l}_{12} \qquad ( 2 )$$

at which point the structure implicit in (1) has apparently been obscured. We will return to the details of this example shortly.
3.1.2 Cardinality

Structure is also present in the sets of axioms used to encode the pigeonhole problem, which is known to be exponentially difficult for any resolution-based method. The pigeonhole problem can be solved in polynomial time if we extend our representation to include cardinality axioms such as
x₁+ . . . +xₘ≧k (3)
The single axiom (3) is equivalent to

$$( \begin{matrix}m \\ k - 1\end{matrix} )$$

conventional disjunctions.

Once again, we will have use for an example presented in full detail. Suppose that we have the constraint
x₁+x₂+x₃+x₄+x₅≧3 (4)
saying that at least 3 of the xᵢ's are true. This is equivalent to
x₁ [symbol] x₂ [symbol] X₃
x₁ [symbol] x₂ [symbol] x₄
x₁ [symbol] x₂ [symbol] x₅
x₁ [symbol] x₃ [symbol] x₄
x₁ [symbol] x₃ [symbol] x₅
x₁ [symbol] x₄ [symbol] x₅
x₂ [symbol] x₃ [symbol] x₄
x₂ [symbol] x₃ [symbol] x₅
x₂ [symbol] x₄ [symbol] x₅
x₃ [symbol] x₄ [symbol] x₅ (3)
3.1.3 Parity Constraints

Finally, we consider constraints that are most naturally expressed using modular arithmetic or exclusive or's, such as
x₁⊕ . . . ⊕xₖ=0
or
x₁⊕ . . . ⊕xₖ=1 (6)
In either case, the parity of the sum of the xᵢ's is specified.

It is well known that axiom sets consisting of parity constraints in isolation can be solved in polynomial time using Gaussian elimination, but there are examples that are exponentially difficult for resolution-based methods. As in the other examples we have discussed, single axioms such as (6) reveal structure that a straightforward Boolean axiomatization obscures. In this case, the single axiom (6) with k=3 is equivalent to:
x₁ [symbol] x₂ [symbol] x₃
x₁ [symbol] [symbol] x₂ [symbol] [symbol] x₃ [symbol]
x₁ [symbol] x₂ [symbol] [symbol] x₃ [symbol]
x₁ [symbol] [symbol] x₂ [symbol] x₃ (7)
3.2 Formalizing Structure

Of course, the ground axiomatizations (2), (5) and (7) cannot erase the structure in the original axioms (1), (4) and (6); they can only obscure that structure. Our goal in this section is to begin the process of understanding the structure in a way that lets us describe it in general terms.

As a start, note that each of the axiom sets consists of axioms of equal length; it follows that the axioms can all be obtained from a single one simply by permuting the literals in the theory. In (2) and (5), literals are permuted with other literals of the same sign; in (7), literals are permuted with their negated versions. But in every instance, a permutation suffices.

In general, the collection of permutations on a set L is denoted by Sym(L). If the elements of L can be labeled 1, 2, . . . , n in some obvious way, the collection is often denoted simply Sₙ. If we take L to be the integers from 1 to n, a particular permutation can be denoted by a series of disjoint cycles, so that the permutation
w=(135)(26) (8)
for example, would map 1 to 3, then 3 to 5, then 5 back to 1. It would also exchange 2 and
6. The order in which the disjoint cycles are written is irrelevant, as is the choice of first element within a particular cycle.

If w₁ and w₂ are two permutations, it is obviously possible to compose them; we will write the composition as w₁w₂ where the order means that we operate on a particular element of {1, . . . , n} first with w₁ and then with w₂. It is easy to see that while composition is associative, it is not necessarily commutative.

As an example, if we compose w from (8) with itself, we get
w²=(135)(26)(135)(26)=(135)(135)(26)(26)=(153)
where the second equality holds because disjoint cycles commute and the third holds because (26)² is the identity cycle ( ).

The composition operator also has an inverse, since any permutation can obviously be inverted by mapping x to that y with w(y)=x. In our running example, it is easy to see that
w⁻¹=(153)(26)

We see, then, that the set Sₙ is equipped with a binary operator that is associative, and has an inverse and an identity element. This is the definition of an algebraic structure known as a group. We draw heavily on results from group theory and some familiarity with group-theoretic notions is helpful for understanding the present invention. One definition and some notation we will need:

Definition 3.1 A subset S of a group G will be called a subgroup of G if S is closed under the group operations of inversion and multiplication. We will write S≦G to denote the fact that S is a subgroup of G, and will write S<G if the inclusion is proper.

For a finite group, closure under multiplication suffices.

But let us return to our examples. The set of permutations needed to generate (5) from the first ground axiom alone is clearly just the set
Ω=Sym({x₁,x₂,x₃,x₄,x₅}) (9)
since these literals can be permuted arbitrarily to move from one element of (5) to another. Note that the set Ω in (9) is a subgroup of the full permutation group S₂ₙ on 2n literals in n variables, since Q is easily seen to be closed under inversion and composition.

What about the example (7) involving a parity constraint? Here the set of permutations needed to generate the four axioms from the first is given by:
(x₁, [symbol] x₁)(x₂, [symbol] x₂) (10)
(x₁, [symbol] x₁)(x₃, [symbol] x₃) (11)
(x₂, [symbol] x₂)(x₃, [symbol] x₃) (12)
Although literals are now being exchanged with their negations, this set, too, is closed under the group inverse and composition axiom. Since each element is a composition of disjoint transpositions, each element is its own inverse. The composition of the first two elements is the third.

The remaining example (2) is a bit more subtle; perhaps this is to be expected, since the axiomatization (2) obscures the underlying structure far more effectively than does either (5) or (7).

To understand this example, note that the set of axioms (2) is “generated” by a set of transformations on the underlying variables. In one transformation, we swap the values of A and B for x, corresponding to the permutation
(a(A,A),a(B,A))(a(A,B),a(B,B))(c(A,A),c(B,A))(c(A,B),c(B,B))
where we have included in a single permutation the induced changes to all of the relevant ground literals. (The relation b doesn't appear because b does not have x as an argument in (1).) In terms of the literals in (7), this becomes
wₓ=(l₁l₃)(l₂l₄)(l₉l₁₁)(l₁₀l₁₂)
In a similar way, swapping the two values for y corresponds to the permutation
w_{y}=(l₁l₂)(l₃l₄)(l₅l₇)(l₆l₈)
and z produces
w_{z}=(l₅l₆)(l₇l₈)(l₉l₁₀)(l₁₁l₁₂)

Now consider the subgroup of Sym({lᵢ}) that is generated by wₓ, w_{y} and w_{z}. We will follow the usual convention and denote this by
Ω= [symbol] wₓw_{y},w_{z} [symbol] (13)

Proposition 3.2 The image of any single clause in the set (2) under Ω as in (13) is exactly the complete set of clauses (2).

As an example, operating on the first axiom in (2) with wₓ produces
l₃ [symbol] l₅ [symbol] l₁₁
This is the fifth axiom, exactly as it should be, since we have swapped a(A,A) with a(B,A) and c(A,A) with c(B,A).

Alternatively, a straightforward calculation shows that
wₓw_{y}=(l₁l₄)(l₂l₃)(l₅l₇)(l₆l₈)(l₉l₁₁)(l₁₀l₁₂)
and maps the first axiom in (5) to the next-to-last, the second axiom to last, and so on.

It should be clear at this point what all of these examples have in common. In every case, the set of ground instances corresponding to a single non-Boolean axiom can be generated from any single ground instance by the elements of a subgroup of the group S₂ₙ of permutations of the literals in the problem. The fact that only a tiny fraction of the subsets of S₂ₙ is closed under the group operations and therefore a subgroup suggests that this subgroup property in some sense captures and generalizes the general idea of structure that underlies our motivating examples.

Note, incidentally, that some structure is surely needed here; a problem in random 3-SAT for example, can always be encoded using a single 3-literal clause c and then that set of permutations needed to recover the entire problem from c in isolation. There is no structure because the relevant subset of S₂ₙ has no structure. The structure is implicit in the requirement that the set Ω used to produce the clauses be a group; as we will see, this structure has just the computational implications needed if we are to lift RBL and other Boolean satisfiability techniques to this broader setting.

Let us also point out the surprising fact that the subgroup idea captures all of the structures discussed in the introduction. It is not surprising that the various structures used to reduce proof size all have a similar flavor, or that the structure used to speed the inner loop be uniform. But it strikes us as remarkable that these two types of structure, used for such different purposes, are in fact instances of a single framework.

Instead of generalizing the language of Boolean satisfiability as seems required by the range of examples we have considered, it suffices to annotate ground clauses with the Ω needed to reproduce a larger axiom set. Before we formalize this, however, let us note that any “reasonable” permutation that switches l₁ and l₂ should respect the semantics of the axiomatization and switch [symbol] l₁ and [symbol] l₂ as well.

Definition 3.3 Given a set of n variables, we will denote by Wₙ that subgroup of S₂ₙ that swaps [symbol] l₁ and [symbol] l₂ whenever it swaps l₁ and l₂.

Informally, an element of Wₙ corresponds to a permutation of the n variables, together with a choice to flip some subset of them.

Proposition 3.4 Wₙ is the wreath product of S₂ and Sₙ, typically denoted S₂ [symbol] Sₙ.

We are now in a position to state:

Definition 3.5 An augmented clause in an n-variable Boolean satisfiability problem is a pair (c, G) where c is a Boolean clause and G≦Wₙ. A ground clause c′ is an instance of an augmented clause (c, G) if there is some gεG such that c′=g(c).

The sections below demonstrate that augmented clauses have the following properties:
1. They can be represented compactly,
2. They can be combined efficiently using a generalization of resolution,
3. They generalize existing concepts such as quantification over finite domains, cardinality, and parity constraints, together with providing natural generalizations for proof techniques involving such constraints and for extended resolution,
4. RBL can be extended with little or no computational overhead to manipulate augmented clauses instead of ground ones, and
5. Propagation can be computed efficiently in this generalized setting.
   3.3 Efficiency of Representation

For the first point, the fact that the augmentations G can be represented compactly is a consequence of G's group structure. In the example surrounding the reconstruction of (5) from (9), for example, the group in question is the full symmetry group on m elements, where m is the number of variables in the cardinality constraint. In the lifting example (7), we can describe the group in terms of the generators wₓ, w_{y} and w_{z} instead of listing all eight elements that the group contains. In general, we have:

Proposition 3.6 Let S be a set of ground clauses, and (c, G) an equivalent augmented clause. Then a set of generators for G=( [symbol] w₁, . . . , wₖ [symbol] can be found in polynomial time such that k≦log₂|G|.

Let us make a remark regarding computational complexity. Essentially any group-theoretic construct can be computed in time polynomial in the group size; basically one simply enumerates the group and evaluates the construction (generate and test, as it were). What is interesting is the collection of group constructions that can be computed in time polynomial in the number of generators of the group. In our case, this corresponds to polylog time in the number of instances of the augmented clauses involved.

In any event, Proposition 3.6 is the first of the results promised: In any case where n Boolean axioms can be captured as instances of an augmented clause, that augmented clause can be represented using O(log₂ n) generators.

The proof of Proposition 3.6 requires the following result from group theory:

Theorem 3.7 (Lagrange) If G is a finite group and S≦G, then |S| divides |G|.

Corollary 3.8 Any augmented clause in a theory containing n literals can be expressed in O(n² log₂ n) space.

In fact, Corollary 3.8 can be strengthened using:

Proposition 3.9 Any subgroup of Sₙ can be described in polynomial time using at most O(n) generators.

This reduces the O(n² log₂ n) in the corollary to simply O(n²).

4 Inference

4.1 Resolution

In this section, we begin the process of discussing derivations based on augmented clauses instead of ground ones. We begin with a few preliminaries:

Definition 4.1 Two augmented clauses (c₁, G₁) and (c₂, G₂) will be called equivalent if they have identical sets of instances. This will be denoted (c₁, G₁)≡(c₂, G₂).

Proposition 4.2 Let (c, G) be an augmented clause. Then if c′ is any instance of (c, G), (c, G)≡(c′, G).

Proposition 4.3 For ground clauses c₁ and c₂ and a permutation wεWₙ,
resolve(w(c₁),w(c₂))=w(resolve(c₁,c₂))

Definition 4.4 If C is a set of augmented clauses, we will say that C entails an augmented clause (c, G), writing C|=(c, G), if every instance of (c, G) is entailed by the set of instances of the augmented clauses in C.

Lemma 4.5 If G₁ and G₂ are subgroups of G, so is G₁∩G₂.

We are now in a position to consider lifting the idea of resolution to our setting, but let us first discuss the overall intent of this lifting and explain an approach that doesn't work.

What we would like to do is to think of an augmented clause as having force similar to all of its instances; as a result, when we resolve two augmented clauses (c₁, G₁) and (C₂, G₂), we would like to obtain as the (augmented) resolvent the set of all resolutions that are sanctioned by resolving an instance of (c₁, G₁) with one of (c₂, G₂). At a minimum, we can certainly conclude (c, G₁∩G₂) where c is the conventional resolvent of c₁ and c₂, since every instance corresponds to a permutation that is sanctioned by the individual augmented resolvents. Is this good enough?

Consider an example. Suppose that there are four variables in our problem, a, b, c and d and that we are resolving the two clauses
(a [symbol] b, [symbol] (bc) [symbol] )
which has instances a [symbol] b and a [symbol] c and
( [symbol] a [symbol] d, [symbol] [symbol] )
which has the single instance [symbol] a [symbol] d. We will write these somewhat more compactly as
(a [symbol] b,(bc)) (14)
and
( [symbol] a [symbol] d,1) (15)
respectively. If we resolve and intersect the groups, we conclude
(b [symbol] d,1)

If we resolve the clauses individually, however, we see that we should be able to derive the pair of clauses b [symbol] d and c [symbol] d; in other words, the augmented clause
(b [symbol] d,(bc)) (16)
It certainly seems as if it should be possible to capture this in our setting, since the clause in (16) is just the resolvent of the clauses appearing in (14) and (15). Where does the group generated by (bc) come from?

If we want to retain the idea of intersecting the groups in the original clauses, the most natural approach seems to be to recognize that neither b nor c appears in (15), so that we can rewrite (15) in the equivalent form
( [symbol] a [symbol] d,(bc)) (17)
because exchanging b and c in [symbol] a [symbol] d has no effect at all. The group (bc) in (16) is now the intersection of the groups in (14) and (17), as desired.

Unfortunately, there are two problems with this idea. The simpler is that it seems inappropriate to require that an augmented version of the clause [symbol] a [symbol] d refer explicitly to the remaining variables in the theory (b and c). Surely the representation of a clause should be independent of the problem of which that clause is a part.

More serious, however, is that the approach that we have just given simply doesn't work. Suppose that we augment our existing theory with a fifth variable e. Now assuming that we keep track of all of the unmentioned variables in the augmented clauses, (14) becomes
(a [symbol] b,(bc)×W_{de}) (18)
where W_{de} denotes the group that exchanges d and e arbitrarily and may flip either (or both) of them as well. We continue to be able to exchange b and c, of course. In an analogous way, (15) becomes
( [symbol] a [symbol] d W_{{bce}}) (19)
where we indicate that we are free to swap b, c and e in any way consistent with Definition 3.3 of the Wᵢ.

It is not hard to see that
W_{{bce}}∩((bc)×W_{de})=(bc)×Wₑ
so that the result of resolving (18) and (19) would be
(b [symbol] d,(bc)×Wₑ)
This appears to be successful, but is not, because the resolvent needs instead to be
(b [symbol] d,(bc)×Wₐₑ)
if we are to continue to resolve with other augmented clauses. We have lost the implicit symmetry resulting from the fact that a has been eliminated from the resolved clause.

The difficulties become clearer if we imagine resolving
(a [symbol] b,Sym({bcd}))
corresponding to the three clauses a [symbol] b, a [symbol] c and a [symbol] d, with
( [symbol] a [symbol] e,(de))
corresponding to [symbol] a [symbol] e and [symbol] a [symbol] d. The clauses that are sanctioned by the resolution should be
b [symbol] d
b [symbol] e
c [symbol] d
c [symbol] e
d [symbol] e
where we have not included d [symbol] d because it would correspond to a permutation where both b and e are mapped to d.

The difficulty is that there is no subgroup of the permutation group that concisely captures the above clauses. It appears that the best that we can do is the following:

Definition 4.6 Let w be a permutation and S a set. Then by w|_{S} we will denote the result of restricting the permutation to the given set.

Definition 4.7 For Kᵢ⊂L and Gᵢ≦Sym(L), we will say that a permutation wεSym(L) is an extension of {Gᵢ} if there are gᵢεGᵢ such that for all i, w|_{K}_{ᵢ}=gᵢ|_{K}_{ᵢ}. We will denote the set of extensions of {Gᵢ} by extn(Kᵢ, Gᵢ).

The extensions need to simultaneously extend elements of all of the individual groups Gᵢ, acting on the various subsets Kᵢ.

Definition 4.8 Suppose that (c₁, G₁) and (c₂, G₂) are augmented clauses. Then a resolvent of (c₁, G₁) and (c₂, G₂) is any augmented clause of the form (resolve(c₁, c₂), G) where G≦(extn(cᵢ, Gᵢ)∩Wₙ).

Proposition 4.9 Augmented resolution is sound, in that
(c₁,G₁)/ [symbol] (c₂,G₂)|=(c,G)
for any (c, G) that is a resolvent of (c₁, G₁) and (c₂, G₂).

We also have:

Proposition 4.10 If extn(cᵢ, Gᵢ)∩Wₙ is a subgroup of Wₙ, then augmented resolution is complete in the sense that
(resolve(c₁,c₂),extn(cᵢ,Gᵢ)∩Wₙ)|=resolve(w(c₁),w(c₂))
for any permutation of literals WεWₙ such that w|_{c}_{₁}εG₁ and w|_{c}_{₂}εG₂.

In general, however, the set of extensions need not be a subgroup of Wₙ, and we would like a less ambiguous construction. To that end, we can modify Definition 4.7 as follows:

Definition 4.11 For Kᵢ⊂L and Gᵢ≦Sym(L), we will say that a permutation wεSym(L) is a stable extension of {Gᵢ} if there are gᵢεGᵢ such that for all i, w|_{G}_{ᵢ}_{(K}_{ᵢ}₎=gᵢ|_{G}_{ᵢ}_{(K}_{ᵢ}₎. We will denote the set of stable extensions of {Gᵢ} by stab(Kᵢ, Gᵢ).

This definition is modified from Definition 4.7 only in that the restriction of w is not just to the original variables in Kᵢ but to Gᵢ(Kᵢ), the image of Kᵢ under the action of the group Gᵢ.

Proposition 4.12 stab(Kᵢ, Gᵢ)≦Sym(L).

In other words, stab(Kᵢ, Gᵢ) is a subgroup of Sym(L).

Definition 4.13 Suppose that (c₁, G₁) and (c₂, G₂) are augmented clauses. Then the canonical resolvent of (c₁, G₁) and (c₂, G₂), to be denoted by resolve((c₁, G₁), (c₂, G₂)), is the augmented clause (resolve(c₁, c₂), stab(cᵢ, Gᵢ)∩Wₙ).

Although this definition is stronger than one involving intersection, note that we might have
(c,G)|=(c′,G′)
but not have
resolve((c,G),(d,H))|=resolve((c′,G′),(d,H))
The reason is that if c=c′ but G′<G, the image of c under G may be larger than the image under G′, making the requirement of stability for images under G more stringent than the requirement of stability for images under G′. We know of no examples where this phenomenon occurs in practice, although one could presumably be constructed.

Proposition 4.14 resolve((c₁, G), (c₂, G))≡(resolve(c₁, c₂), G).

Proposition 4.15 resolve((c₁, G₁), (c₂, G₂))|=(resolve(c₁, c₂), G₁∩G₂).

There is a variety of additional remarks to be made about Definition 4.13. First, the resolvent of two augmented clauses can depend on the choice of the representative elements in addition to the choice of subgroup of extn(cᵢ, Gᵢ). Thus, if we resolve
(l₁,(l₁l₂)) (20)
with
( [symbol] l₁,1) (21)
we get a contradiction. But if we rewrite (20) so that we are attempting to resolve (21) with
(l₂,(l₁l₂))
no resolution is possible at all.

We should also point out that there are computational issues involved in either finding a subgroup of extn(cᵢ, Gᵢ) or evaluating the specific subgroup stab(cᵢ, Gᵢ). If the component groups G₁ and G₂ are described by listing their elements, an incremental construction is possible where generators are gradually added until it is impossible to extend the group further without violating Definition 4.8 or Definition 4.13. But if G₁ and G₂ are described only in terms of their generators as suggested by Proposition 3.6, computing either stab(cᵢ, Gᵢ) or a maximal subgroup of extn(cᵢ, Gᵢ) involves the following computational subtasks:
1. Given a group G and set C, find the subgroup G′≦G of all gεG such that G′(C)=C. This set is easily seen to be a subgroup and is called the set stabilizer of C. It is often denoted G_{{c}}.
2. Given a group G and set C, find the subgroup G′≦G of all gεG such that g(c)=c for every cεC. This set is also a subgroup and is called the pointwise stabilizer of C. It is typically denoted G_{C}.
3. Given two groups G₁ and G₂ described in terms of generators, find a set of generators for G₁∩G₂.
4. Given G and C, let wεG_{{c}}. Now w|_{C}, the restriction of w to C, makes sense because w(C)=C. Given a ρ that is such a restriction, find an element ρ′εG such that ρ′|_{C}=ρ.

Although the average case complexity of the above operations appears to be polynomial, the worst case complexity is known to be polynomial only for the second and fourth. The worst case for the other two tasks is unknown but is generally believed not to be in P (as usual, in terms of the number of generators of the groups, not their absolute size).

In the introduction, we claimed that the result of resolution was unique using reasons and that, “The fundamental inference step in ZAP is in NP with respect to the ZAP representation, and therefore has worst case complexity exponential in the representation size (i.e., polynomial in the number of Boolean axioms being resolved). The average case complexity appears to be low-order polynomial in the size of the ZAP representation.” The use of reasons breaks the ambiguity surrounding (20) and (21), and the remarks regarding complexity correspond to the computational observations just made.

4.2 Introduction of New Groups

There is another type of inference that is possible in the ZAP setting. Suppose that we have derived
a [symbol] b
and
a [symbol] c
or, in augmented form,
(a/ [symbol] b,1) (22)
and
(a [symbol] c,1) (23)

Now we would like to be able to replace the above axioms with the single
(a [symbol] b,(bc)) (24)

Not surprisingly, this sort of replacement will underpin our eventual proof that augmented resolution can p-simulate extended resolution.

Definition 4.16 Let S={(cᵢ,Gᵢ)} be a set of augmented clauses. We will say that an augmented clause (c, G) follows from S by introduction if every instance of (c, G) is an instance of one of the (cᵢ, Gᵢ).

Lemma 4.17 Let S be a set of augmented clauses. Then an augmented clause (c, G) follows from S by introduction if there is a single (c₀, G₀)εS such that c is an instance of (c₀, G₀) and G≦G₀.

Note that the converse does not hold. If S={(a, (abc))} and the augmented clause (c, G) is (a, (ab)), then (c, G) has as instances a and b, each of which is an instance of the single augmented clause in S. But the group generated by (ab) is not a subgroup of the group generated by (abc).

There is one additional technique that we will need. Suppose that we know
a [symbol] x (25)
and
b [symbol] y (26)
and want to conclude a [symbol] b [symbol] (x [symbol] y) or, in our terms, the augmented clause
(a [symbol] b [symbol] x, (xy)) (27)
Can we do this via introduction?

We would like to, but we cannot. The reason is that the instances of (27) do not actually appear in (25) or (26); a [symbol] b [symbol] x is not an instance of a [symbol] a, but is instead a weakening of it. (This definition describes weakening the clausal part of an augmented clause; weakening the group by restricting to a subgroup is covered by introduction as described in Lemma 4.17.)

Definition 4.18 An augmented clause (c′, G) is a weakening of an augmented clause (c, G) if c′ is a superset of c.

It is known that proof lengths under resolution or extended resolution do not change if weakening is included as an allowable inference. (Roughly speaking, the literals introduced during a weakening step just have to be resolved away later anyway.) For augmented resolution, this is not the case.

As we will see in the next section, introduction of new groups is equivalent to the introduction of new variables in extended resolution. Unlike extended resolution, however, where it is unclear when new variables should be introduced and what those variables should be, the situation in ZAP is clearer because the new groups are used to collapse the partitioning of a single augmented clause. One embodiment of ZAP itself does not include introduction as an inference step.

5 Examples and Proof Complexity

Let us now turn to the examples that we have discussed previously: first-order axioms that are quantified over finite domains, along with the standard examples from proof complexity, including pigeonhole problems, clique coloring problems and parity constraints. For the first, we will see that our ideas generalize conventional notions of quantification while providing additional representational flexibility in some cases. For the other examples, we will present a ground axiomatization, recast it using augmented clauses, and then give a polynomially sized derivation of unsatisfiability using augmented resolution. Finally, we will show that augmented resolution can p-simulate extended resolution.

5.1 Lifted Clauses and QPROP

To deal with lifted clauses, suppose that we have a quantified clause such as
∀xyz.a(x,y) [symbol] b(y,z) [symbol] c(z) (28)

We will assume for simplicity that the variables have a common domain D, so that a grounding of the clause (28) involves working with a map that takes a pair of elements d₁, d₂ of D and produces the ground variable corresponding to a(d₁, d₂). In other words, if V is the set of variables in our problem, there is an injection
a: D×D→V
In a similar way, there are injections
b: D×D→V
and
c: D→V
where the images of a, b and c are disjoint and each is an injection because distinct relation instances must be mapped to distinct ground atoms.

Now given a permutation w of the elements of D, it is not hard to see that w induces a permutation wₓ on V given by:

$${ω}_{x} ( υ ) = \{ \begin{matrix}a ( ω ( x ) , y ) , & if υ = a ( x , y ) ; \\ υ ; & otherwise .\end{matrix}$$

In other words, there is a mapping x from the set of permutations on D to the set of permutations on V:
x: Sym(D)→Sym(V)

Definition 5.1 Let G and H be groups and f: G→H a function between them. f will be called a homomorphism if it respects the group operations in that f(g₁g₂)=f(g₁)f(g₂) and f(g⁻¹)=a(g)⁻¹.

Proposition 5.2×: Sym(D)→Sym(V) is an injection and a homomorphism.

In other words, x makes a “copy” of Sym(D) inside of Sym(V) corresponding to permuting the elements of x's domain.

In a similar way, we can define homomorphisms y and z given by

$${ω}_{y} ( υ ) = \{ \begin{matrix}a ( x , ω ( y ) ) , & if υ = a ( x , y ) ; \\ b ( ω ( y ) , z ) , & if υ = b ( y , z ) ; \\ υ ; & otherwise .\end{matrix} \\ and \\ {ω}_{z} ( υ ) = \{ \begin{matrix}b ( y , ω ( z ) ) , & if υ = b ( y , z ) ; \\ c ( ω ( z ) ) , & if υ = c ( z ) ; \\ υ ; & otherwise .\end{matrix}$$

Now consider the subgroup of Sym(V) generated by wₓ(Sym(D)), w_{y}(Sym(D)) and w_{z}(Sym(D)). It is clear that the three subgroups commute with one another, and that their intersection is only the trivial permutation. This means that x, y and z collectively inject the product D×D×D into Sym(V); we will denote this by
xyz: D³→Sym(V)
and it should be clear that the original quantified axiom (28) is equivalent to the augmented axiom
(a(A,B) [symbol] b(B,C) [symbol] c(C),xyz(D³))
where A, B and C are any (not necessarily distinct) elements of D. The quantification is exactly captured by the augmentation.

An interesting thing is what happens to resolution in this setting:

Proposition 5.3 Let p and q be quantified clauses such that there is a term tₚ in p and [symbol] t_{q} in q where tₚ and t_{q} have common instances. Suppose also that (p_{g}, P) is an augmented clause equivalent to p and (q_{g}, Q) is an augmented clause equivalent to q, with p_{g} and q_{g} resolving nontrivially. Then if no other terms in p and q have common instances, the result of resolving p and q in the conventional lifted sense is equivalent to resolve((p_{g}, P), (q_{g}, Q)).

Note that the condition requiring lack of commonality of ground instances is necessary; consider resolving
a(x) [symbol] b
with
a(y) [symbol] [symbol] b

In the quantified case, we get
∀xy.a(x) [symbol] a(y) (29)

In the augmented case, it is not hard to see that if we resolve (a(A) [symbol] b, G) with (a(A) [symbol] [symbol] b, G) we get
(a(A),G)
corresponding to
∀x.a(x) (30)
while if we choose to resolve (a(A) [symbol] b, G) with (a(B) [symbol] [symbol] b, G), we get instead
∀x≠y.a(x) [symbol] a(y)

It is not clear which of these representations is superior. The conventional (29) is more compact, but obscures the fact that the stronger (30) is entailed as well. This particular example is simple, but other examples involving longer clauses and some residual unbound variables can be more complex.

5.2 Proof Complexity without Introduction

5.2.1 Pigeonhole Problems

Of the examples known to be exponentially difficult for conventional resolution-based systems, pigeonhole problems are in many ways the simplest. As usual, we will denote by Pᵢⱼ the fact that pigeon i (of n+1) is in hole j of n, so that there are n²+n variables in the problem. We denote by G the subgroup of Wₙ_{²}₊ₙ that allows arbitrary exchanges of the n+1 pigeons or the n holes, so that G is isomorphic to Sₙ₊₁×Sₙ. This is the reason that this particular example will be so straightforward: there is a single global group that we will be able to use throughout the entire analysis.

Our axiomatization is now:
( [symbol] p₁₁ [symbol] p₂₁,G) (31)
saying that no two pigeons can be in the same hole, and
(p₁₁ [symbol] . . . [symbol] p₁ₙ,G) (32)
saying that the first (and thus every) pigeon has to be in some hole.

Proposition 5.4 There is an augmented resolution proof of polynomial size of the mutual unsatisfiability of (31) and (32).

Proposition 5.5 Any implementation of Procedure 2.10 that branches on positive literals in unsatisfied clauses on line 14 will produce a proof of polynomial size of the mutual unsatisfiability of (31) and (32), independent of specific branching choices made.

This strikes us as a remarkable result: Not only is it possible to find a proof of polynomial length in the augmented framework, but in the presence of unit propagation, it is difficult not to!

5.2.2 Clique Coloring Problems

The pigeonhole problem is difficult for resolution but easy for many other proof systems; clique coloring problems are difficult for both resolution and other approaches such as pseudo-Boolean axiomatizations.

The clique coloring problems are derivatives of pigeonhole problems where the exact nature of the pigeonhole problem is obscured. Somewhat more specifically, they say that a graph includes a clique of n+1 nodes (where every node in the clique is connected to every other), and that the graph must be colored in n colors. If the graph itself is known to be a clique, the problem is equivalent to the pigeonhole problem. But if we know only that the clique can be embedded into the graph, the problem is more difficult.

To formalize this, we will use eᵢⱼ to describe the graph, cᵢⱼ to describe the coloring of the graph, and qᵢⱼ to describe the embedding of the cliQue into the graph. The graph has m nodes, the clique is of size n+1, and there are n colors available. The axiomatization is: [symbol]
eᵢⱼ [symbol] [symbol] cᵢₗ [symbol] cⱼₗ for 1≦i<j≦m, 1, . . . , n (33)
cᵢ₁ [symbol] . . . [symbol] cᵢₙ for i=1, . . . , m (34)
qᵢ₁ [symbol] . . . [symbol] qᵢₘ for i=1, . . . , n+1 (35) [symbol]
qᵢⱼ [symbol] [symbol] qₖⱼ for 1≦i<k≦n+1, j=1, . . . , m (36)
eᵢⱼ [symbol] [symbol] qₖᵢ [symbol] qₗⱼ for 1≦i<j≦m, 1≦k≠l≦n+1 (37)

Here eᵢⱼ means that there is an edge between graph nodes i and j, cᵢⱼ means that graph node i is colored with the jth color, and qᵢⱼ means that the ith element of the clique is mapped to graph node j. Thus the first axiom (33) says that two of the m nodes in the graph cannot be the same color (of the n colors available) if they are connected by an edge. (34) says that every graph node has a color. (35) says that every element of the clique appears in the graph, and (36) says that no two elements of the clique map to the same node in the graph. Finally, (37) says that the clique is indeed a clique—no two clique elements can map to disconnected nodes in the graph. As in the pigeonhole problems, there is a global symmetry in this problem in that any two nodes, clique elements or colors can be swapped.

Proposition 5.6 There is an augmented resolution proof of polynomial size of the mutual unsatisfiability of (33)-(37).

5.2.3 Parity Constraints

Rather than discuss a specific example here, we can show the following:

Proposition 5.7 Let C be a theory consisting entirely of parity constraints. Then determining whether or not C is satisfiable is in P for augmented resolution.

Definition 5.8 Let S be a subset of a set of n variables. We will denote by F_{S} that subset of Wₙ consisting of all permutations that leave the variable order unchanged and flip an even number of variables in S.

Lemma 5.9 F_{S}≦Wₙ.

Lemma 5.10 Let S={x₁, . . . , xₖ} be a subset of a set of n variables. Then the parity constraint
Σxᵢ≡1 (38)
is equivalent to the augmented constraint
(x₁ [symbol] . . . [symbol] xₖ,F_{S}) (39)

The parity constraint
Σxᵢ≡0
is equivalent to the augmented constraint
( [symbol] x₁ [symbol] x₂ [symbol] . . . [symbol] xₖ,F_{S})

The construction in the proof fails in the case of modularity constraints with a base other than 2. One of the (many) problems is that the set of permutations that flip a set of variables of size congruent to m (mod n) is not a group unless m=0 and n<3. We need m=0 for the identity to be included, and since both
(x₁, [symbol] x₁) . . . (xₙ, [symbol] xₙ)
and
(x₂, [symbol] x₂) . . . (xₙ₊₁+, [symbol] xₙ₊₁)
are included, it follows that
(x₁, [symbol] x₁)(xₙ₊₁,xₙ₊₁)
must be included, so that n=1 or n=2.
5.3 Extended Resolution and Introduction

We conclude this section by describing the relationship between our methods and extended resolution. As a start, we have:

Definition 5.11 An extended resolution proof for a theory T is one where T is first augmented by a collection of sets of axioms, each set of the form

$$\begin{matrix}⫬ {x}_{1} ⋁ … ⋁ ⫬ {x}_{n} ⋁ w \\ {x}_{1} ⋁ ⫬ w \\ ⋮ \\ {x}_{n} ⋁ ⫬ w\end{matrix} \qquad ( 40 )$$

where x₁, . . . , xₙ are literals in the (possibly already extended) theory T and w is a new variable. Derivation then proceeds using conventional resolution on the augmented theory.

The introduction defines the new variable w equivalent to the conjunction of the xᵢ's. This suffices to allow the definition of an equivalent to any subexpression, since de Morgan's laws can be used to convert disjunctions to conjunctions if need be. A conventional definition of extended resolution allows only n=2, since complex terms can be built up from pairs. The equivalent definition that we have given makes the proof of Theorem 5.12 more convenient.

Theorem 5.12

1. If resolution cannot p-simulate a proof system P, neither can augmented resolution without introduction.
2. Augmented resolution with introduction and weakening can p-simulate extended resolution.

This theorem, together with the results of the previous subsection, support the proof complexity claims made for ZAP in the introduction.

6 Theoretical and Procedural Description

In addition to resolution, an examination of Procedures 2.10 and 2.7 shows that we need to be able to eliminate nogoods when they are irrelevant and to identify instances of augmented clauses that are unit. Let us now discuss each of these issues.

The problems around irrelevance are incurred only when a new clause is added to the database and are therefore not in the ZAP inner loop. Before discussing these in detail, however, let us discuss a situation involving the quantified transitivity axiom [symbol]
a(x,y) [symbol] [symbol] a(y,z) [symbol] a(x,z)

Now if we are trying to derive a(A, B) for an A and a B that are “far apart” given the skeleton of the relation a that we already know, it is possible that we derive
a(A,x) [symbol] a(x,B)→a(A,B)
as we search for a proof involving a single intermediate location, and then
a(A,x) [symbol] a(x,y) [symbol] a(y,B)→a(A,B)
as we search for a proof involve two such locations, and so on, eventually concluding
a(A,x₁) [symbol] . . . [symbol] a(xₙ,B)→a(A,B) (41)
for some suitably large n. The problem is that if d is the size of our domain, (41) will have d²ⁿ⁻² ground instances and is in danger of overwhelming our unit propagation algorithm even in the presence of reasonably sophisticated subsearch techniques. We argued previously that this problem requires that we learn only a version of (41) for which every instance is relevant. A way to do this is as follows:

Procedure 6.1 Given a SAT problem C and an annotated partial assignment P, to compute learn (C, P, (c, G)), the result of adding to C an augmented clause (c, G):

| | |
|---|---|
| 1 | remove from C any (d, H) for which every instance d′ |
| | has poss(d′, P) > k |
| 2 | {gᵢ} [symbol] the generators of G |
| 3 | S [symbol] Ø |
| 4 | while there is a g ∈ {gᵢ} - S such that ∀d ∈ (c, <S ∪ {g}>) · |
| | poss(d, P) ≦ k |
| 5 | do select such a g |
| 6 | S [symbol] S ∪ {g} |
| 7 | return C ∪ {(c, <S>)} |

The procedure gradually adds generators of the group until it is impossible to add more without introducing an irrelevant clause (or perhaps because the entire group G has been added). We will defer until below a discussion of a procedure for determining whether (c, [symbol] S∪{g} [symbol] ) has an irrelevant instance or whether (d, H) has only irrelevant instances as checked in line 1.

We will also defer discussion of a specific procedure for computing unit-propagate (P), but do include a few theoretical comments at this point. In unit propagation, we have a partial assignment P and need to determine which instances of axioms in C are unit. To do this, suppose that we denote by S(P) the set of Satisfied literals in the theory, and by U(P) the set of Unvalued literals. Now for a particular augmented clause (c, G), we are looking for those gεG such that g(c)∩S(P)=Ø and |g(c)∩U(P)|≦1. The first condition says that g(c) has no satisfied literals; the second, that it has at most one unvalued literal.

Procedure 6.2 (Unit propagation) To compute UNIT-PROPAGATE(P) for an annotated partial assignment P= [symbol] (l₁, c₁), . . . , (lₙ, cₙ) [symbol] :

| | |
|---|---|
| 1 | while there is a (c, G) ∈ C and g ∈ G with g(c) ∩ S(P) = |
| | Ø and \|g(c) ∩ U(P)\| ≦ 1 |
| 2 | do if g(c) ∩ U(P) = Ø |
| 3 | then lᵢ [symbol] the literal in g(c) with the highest index in P |
| 4 | return <true, resolve((c, G), cᵢ)> |
| 5 | else l [symbol] the literal in g(c) unassigned by P |
| 6 | add (l, (g(c), G)) to P |
| 7 | return <false, P> |

Note that the addition made to P when adding a new literal includes both g(c), the instance of the clause that led to the propagation, and the augmenting group as usual. We can use (g(c), G) as the augmented clause by virtue of Proposition 4.2.

Finally, the augmented version of Procedure 2.10 is:

Procedure 6.3 (Relevance-bound reasoning, RBL) Given a SAT problem C and an annotated partial assignment P, to compute RBL(C, P):

| | |
|---|---|
| 1 | if P is a solution to C |
| 2 | then return P |
| 3 | <x, y> [symbol] UNIT-PROPAGATE(P) |
| 4 | if x = true |
| 5 | then (c, G) [symbol] y |
| 6 | if c is empty |
| 7 | then return FAILURE |
| 8 | else remove successive elements from P so that c is unit |
| 9 | C [symbol] learn(C, P, (c, G)) |
| 10 | return RBL(C, P) |
| 11 | else P [symbol] y |
| 12 | if P is a solution to C |
| 13 | then return P |
| 14 | else l [symbol] a literal not assigned a value by P |
| 15 | return RBL(C, <P, (l, true)>) |

Examining the previous three procedures, we see that we need to provide implementations of the following:
1. A routine that computes the group of stable extensions appearing in the definition of augmented resolution, needed by line 4 in the unit propagation procedure 6.2.
2. A routine that finds instances of (c, G) for which g(c)∩S=Ø and |g(c)∩U|≦1 for disjoint S and U, needed by line 1 in the unit propagation procedure 6.2.
3. A routine that determines whether (c, G) has instances for which poss(g(c), P)>k for some fixed k, as needed by line 4 in Procedure 6.1.
4. A routine that determines whether (c, G) has an instance for which poss(g(c), P)≦k for some fixed k, as needed by line 1 in Procedure 6.1.

Our focus below is on the development of efficient procedures that achieve these goals.

### 7 CONCLUSION

Our aim in this paper has been to give a theoretical description of a generalized representation scheme for satisfiability problems. The basic building block of the approach is an “augmented clause,” a pair (c, G) consisting of a ground clause c and a group G of permutations acting on it; the intention is that the augmented clause is equivalent to the conjunction of the results of operating on c with elements of G. We argued that the structure present in the requirement that G be a group provides a generalization of a wide range of existing notions, from quantification over finite domains to parity constraints.

We went on to show that resolution could be extended to deal with augmented clauses, and gave a generalization of relevance-based learning in this setting (Procedures 6.1-6.3). We also showed that the resulting proof system generalized first-order techniques when applied to finite domains of quantification, and could produce polynomially sized proofs of the pigeonhole problem, clique coloring problems, Tseitin's graph coloring problems, and parity constraints in general. These results are obtained without the introduction of new variables or other choice points; a resolution in our generalized system is dependent simply on the selection of two augmented clauses to combine. We also showed that if new groups could be introduced, the system was at least as powerful as extended resolution.

Finally, we described the specific group-theoretic problems that need to be addressed in implementing our ideas. As discussed in the previous section, they are:
1. Implementing the group operation associated with the generalization of resolution,
2. Finding unit instances of an augmented clause,
3. Determining whether an augmented clause has irrelevant instances, and
4. Determining whether an augmented clause has relevant instances.

We will return to these issues below.

### IMPLEMENTATION

1 Introduction

Our overall plan for describing an embodiment of ZAP is as follows:
1. We begin in the next section by presenting both the algorithms to be used and repeating the underlying group-theoretic constructs where necessary.
2. We next describe the group-theoretic computations required by the ZAP implementation. The other elements of the procedures in Section 2 all have analogs in existing implementations, and we do not describe them further here.
3. Sections 4 and 5 describe the implementations of the computations discussed in Section 2. (The intervening section 3 gives a brief introduction to some of the ideas in computational group theory that we use.) For each basic construction, we describe the algorithm used and give an example of the computation in action.

After describing the implementation, we describe the interface to one embodiment in Section 6.

2 ZAP Fundamentals and Basic Structure

Let us begin not with ZAP, but with a description of the architecture of modern Boolean satisfiability engines. We start with the unit propagation procedure, which we describe as follows:

Definition 2.1 Given a Boolean satisfiability problem described in terms of a set C of clauses, a partial assignment is an assignment of values (true or false) to some subset of the variables appearing in C. We represent a partial assignment P as a sequence of literals P= [symbol] lᵢ [symbol] where the appearance of vᵢ in the sequence means that vᵢ has been set to true, and the appearance of [symbol] vᵢ means that vᵢ has been set to false.

An annotated partial assignment is a sequence P= [symbol] (lᵢ, cᵢ) [symbol] where cᵢ is the reason for the associated choice lᵢ. If cᵢ=true, it means that the variable was set as the result of a branching decision; otherwise, cᵢ is a clause that follows from C and such that it entails lᵢ by virtue of the choices of the previous lⱼ for j<i. (See above for additional details.)

Given a (possibly annotated) partial assignment P, we denote by S(P) the literals {lᵢ} that are satisfied by P, and by U(P) the set of literals that are unvalued by P.

Procedure 2.2 (Unit propagation) To compute UNIT-PROPAGATE(P) for an annotated partial assignment P= [symbol] (lᵢ, c₁), . . . , (lₙ, cₙ) [symbol] :

| | |
|---|---|
| 1 | while there is a c ∈ C with c ∩ S(P) = Ø and \|c ∩ U(P)\| ≦ 1 |
| 2 | do if c ∩ U(P) = Ø |
| 3 | then lᵢ [symbol] the literal in c with the highest index in P |
| 4 | return <true, resolve(c, cᵢ)> |
| 5 | else l [symbol] the literal in c unassigned by P |
| 6 | P [symbol] P ∪ (l, c) |
| 7 | return <false, P> |

The result returned depends on whether or not a contradiction was encountered during the propagation, with the first result returned being true if a contradiction was found and false if none was found. In the former case (where the clause c has no unvalued literals in line 2), then if c is the clause and cᵢ is the reason that the last variable was set in a way that caused c to be unsatisfiable, we resolve c with cᵢ and return the result as a new no good for the problem in question. Otherwise, we eventually return the partial assignment, augmented to include the variables that have been set during the propagation process.

Given unit propagation, the overall inference procedure is the following:

Procedure 2.3 (Relevance-bound reasoning, RBL) Given a SAT problem C and an annotated partial assignment P, to compute RBL(C, P):

| | |
|---|---|
| 1 | if P is a solution to C |
| 2 | then return P |
| 3 | <x, y> [symbol] UNIT-PROPAGATE(P) |
| 4 | if x = true |
| 5 | then c [symbol] y |
| 6 | if c is empty |
| 7 | then return FAILURE |
| 8 | else remove successive elements from P so that c is unit |
| 9 | C [symbol] learn(C, P, c) |
| 10 | return RBL(C, P) |
| 11 | else P [symbol] y |
| 12 | if P is a solution to C |
| 13 | then return P |
| 14 | else l [symbol] a literal not assigned a value by P |
| 15 | return RBL(C, <P, (l, true)>) |

The procedure is recursive. If at any point we have solved the overall problem, we're done. Otherwise, we propagate with unit propagation; if a contradiction is found and a clause c is returned, we use the (currently unspecified) learn procedure to incorporate c into the solver's current state, and then recurse. (If c is empty, it means that we have derived a contradiction and the procedure fails.) In the backtracking step (line 8), we backtrack not just until c is satisfiable, but until it enables a unit propagation. This leads to increased flexibility in the choice of variables to be assigned after the backtrack is complete, and generally improves performance.

If unit propagation does not indicate the presence of a contradiction, we pick an unvalued literal, set it to true, and recurse again. Note that we don't need to set the literal l to true or false; if we eventually need to backtrack and set I to false, that will be handled by the modification to P in line 8.

Finally, we need to present the procedure used to incorporate a new nogood into the clausal database C. In order to do that, we need to make the following definition:

Definition 2.4 Let [symbol] ᵢlᵢ be a clause, which we will denote by c, and let P be a partial assignment. We will say that the possible value of c under P is given by
poss(c,P)=|{i| [symbol] lᵢ∉P}|−1

If no ambiguity is possible, we will write simply poss(c) instead of poss(c, P). In other words, poss(c) is the number of literals that are either already satisfied or not valued by P, reduced by one (since the clause requires one literal true be true).

Note that poss(c, P)=|c∩[U(P)ÅS(P)]|−1, since each expression is one less than the number of potentially satisfiable literals in C.

The possible value of a clause is essentially a measure of what other authors have called its irrelevance. A clause c with poss(c, P)=0 can be used for unit propagation; if poss(c, P)=1, it means that a change to a single variable can lead to a unit propagation, and so on. The notion of learning used in relevance-bounded inference is now captured by:

Procedure 2.5 Given a SAT problem C and an annotated partial assignment P, to compute learn(C, P, c), the result of adding to C a clause c and then removing irrelevant clauses:
1 remove from C any dεC with poss(d, P)>k
2 return CÅ{c}

In ZAP, we continue to work with these procedures in approximately their current form, but replace the idea of a clause (a disjunction of literals) with that of an augmented clause:

Definition 2.6 An augmented clause in an n-variable Boolean satisfiability problem is a pair (c, G) where c is a Boolean clause and G≦Wₙ. A (nonaugmented) clause c′ is an instance of an augmented clause (c, G) if there is some gεG such that c′=g(c).

Roughly speaking, an augmented clause consists of a conventional clause and a group G of permutations acting on it; the intent is that we can act on the clause with any element of the group and still get a clause that is “part” of the original theory. The group G is required to be a subgroup of Wₙ=S₂ [symbol] Sₙ, which means that each permutation gεG can permute the variables in the problem and flip the signs of an arbitrary subset as well. We showed previously that suitably chosen groups correspond to cardinality constraints, parity constraints (the group flips the signs of any even number of variables), and universal quantification over finite domains.

We must now lift the previous three procedures to an augmented setting. The first two are straightforward. In unit propagation, for example, instead of checking to see if any clause cεC is unit given the assignments in P, we must now check to see if any augmented clause (c, G) has a unit instance. Other than that, the procedure is essentially unchanged from Procedure 2.2:

Procedure 2.7 (Unit propagation) To compute UNIT-PROPAGATE(P) for an annotated partial assignment P= [symbol] (l₁, c₁), . . . , (lₙ, cₙ) [symbol] :

| | |
|---|---|
| 1 | while there is a (c, G) ∈ C and g ∈ G with g(c) ∩ S(P) = Ø |
| | and \|g(c) ∩ U(P)\| ≦ 1 |
| 2 | do if g(c) ∩ U(P) = Ø |
| 3 | then lᵢ [symbol] the literal in g(c) with the highest index in P |
| 4 | return <true, resolve((g(c), G), cᵢ)> |
| 5 | else l [symbol] the literal in g(c) unassigned by P |
| 6 | add (l, (g(c), G)) to P |
| 7 | return <false, P> |

The basic inference procedure itself is also virtually unchanged:

Procedure 2.8 (Relevance-bound reasoning, RBL) Given a SAT problem C and an annotated partial assignment P, to compute RBL(C, P):

| | |
|---|---|
| 1 | if P is a solution to C |
| 2 | then return P |
| 3 | <x, y> [symbol] UNIT-PROPAGATE(P) |
| 4 | if x = true |
| 5 | then (c, G) [symbol] y |
| 6 | if c is empty |
| 7 | then return FAILURE |
| 8 | else remove successive elements from P so that c is unit |
| 9 | C [symbol] learn(C, P, (c, G)) |
| 10 | return RBL(C, P) |
| 11 | else P [symbol] y |
| 12 | if P is a solution to C |
| 13 | then return P |
| 14 | else l [symbol] a literal not assigned a value by P |
| 15 | return RBL(C, <P, (l, true)>) |

In line 5, although unit propagation returns an augmented clause (c, G), the instance c is still the reason for the backtrack; it follows that line 8 is unchanged from the Boolean version.

The tricky part is the learning procedure 2.5, which becomes:

Procedure 2.9 Given a SAT problem C and an annotated partial assignment P, to compute learn(C, P, (c, G)), the result of adding to C an augmented clause (c, G):

| | |
|---|---|
| 1 | remove from C any (d, H) for which every instance d′ has |
| | poss(d′, P) > k |
| 2 | {gᵢ} [symbol] the generators of G |
| 3 | S [symbol] Ø |
| 4 | while there is a g ∈ {gᵢ} - S such that ∀d ∈ |
| | (c, <S ∪ {g}>) . poss(d, P) ≦ k |
| 5 | do select such a g |
| 6 | S [symbol] S ∪ {g} |
| 7 | return C ∪ {(c, <S>)} |

There are two differences from the Boolean case. First, in line 1, we remove not just clauses that are irrelevant, but augmented clauses for which every instance is irrelevant. Presumably, it will be useful to retain the clause as long as it has some relevant instance.

More interesting is the difference in lines 2-6. As we pointed out above, we generally do not want to learn the most general possible resolvent of two existing clauses, since such a resolvent will have many irrelevant instances that slow the search for instances with specific properties in line 1 of the unit propagation procedure 2.7.

Previously, we showed that a proof engine built around the above three procedures would have the following properties:
Since the number of generators of a group is logarithmic in the group size, it would achieve exponential improvements in basic representational efficiency.
Since only k-relevant nogoods are retained as the search proceeds, the memory requirements are polynomial in the size of the problem being solved.
It can produce polynomially sized proofs of the pigeonhole and clique coloring problems, and any parity problem.
If we allow the procedures to be augmented in a way that allows the identification and introduction of new groups, it can p-simulate extended resolution.
It generalizes first-order inference provided that all quantifiers are universal and all domains of quantification are finite.

We stated without proof that the unit propagation procedure 2.7 can be implemented in a way that generalizes both subsearch and the watched literal idea.

2.1 Group-Theoretic Elements

Examining the above three procedures, the elements that are new relative to Boolean engines are the following:
1. In line 1 of the unit propagation procedure 2.7, we need to find unit instances of an augmented clause (c, G).
2. In line 4 of the same procedure 2.7, we need to compute the resolvent of two augmented clauses.
3. In line 1 of the learning procedure 2.9, we need to determine if an augmented clause has any relevant instances.
4. In line 4 of the learning procedure, we need to determine if an augmented clause has any irrelevant instances.

The first, third and fourth of these needs are different from the second. For resolution, we need the following definition:

Definition 2.10 For a permutation p and set S with p(S)=S, by p|_{S} we will mean the restriction of p to the given set, and we will say that p is a lifting of p|_{S} back to the original set on which p acts.

Definition 2.11 For Kᵢ⊂L and Gᵢ≦Sym(L), we will say that a permutation wεSym(L) is a stable extension of {Gᵢ} if there are gᵢεGᵢ such that for all i, w|_{G}_{ᵢ}_{(K}_{ᵢ}₎=gᵢ|_{G}_{ᵢ}_{(K}_{ᵢ}₎. We will denote the set of stable extensions of {Gᵢ} by stab(Kᵢ, Gᵢ).

The set of stable extensions stab(Kᵢ, Gᵢ) is closed under composition, and is therefore a subgroup of Sym(L).

Definition 2.12 Suppose that (c₁, G₁) and (c₂, G₂) are augmented clauses. Then the (canonical) resolvent of (c₁, G₁) and (c₂, G₂), to be denoted by resolve((c₁, G₁), (c₂, G₂)), is the augmented clause (resolve(c₁, c₂), stab(cᵢ, Gᵢ)∩Wₙ).

It follows from the above definitions that computing the resolvent of two augmented clauses as required by Procedure 2.7 is essentially a matter of computing the set of stable extensions of the groups in question. We will return to this problem in Section 4.

The remaining problems can all be viewed as instances of the following:

Definition 2.13 Let c be a clause, viewed as a set of literals, and G a group of permutations acting on c. Now fix sets of literals S and U, and an integer k. We will say that the k-transporter problem is that of finding a gεG such that g(c)∩S=Ø and |g(c)∩U|≦k, or reporting that no such g exists.

All of the remaining problems we have discussed are instances of the k-transporter problem. To find a unit instance of (c, G), we set S to be the set of satisfied literals and U the set of unvalued literals. Taking k=1 implies that we are searching for an instance with no satisfied and at most one unvalued literal.

To find a relevant instance, we set S=Ø and U to be the set of all satisfied or unvalued literals. Taking k to be the relevance bound corresponds to a search for a relevant instance.

To find an irrelevant instance, we continue to set S=Ø, and take U to be the set of all unsatisfied literals. Now if the relevance bound is r, we set k=|c|−r−1. After all, if the clause contains at most |c|−r−1 unsatisfied literals, it will contain at least r+1 satisfied or unvalued literals, so that poss(g(c))>r and the instance will be irrelevant.

The remainder of the theoretical material in this paper is therefore focused on these two problems: Computing the stable extensions of a pair of groups, and solving the k-transporter problem. Before we discuss the techniques used to solve these two problems, we present a brief overview of computational group theory generally.

3 Computational Group Theory

Background information on group theory can be found in Rotman's An Introduction to the Theory of Groups and Seress' Permutation Group Algorithms, both of which are hereby incorporated by reference herein.

Our goal here is to provide enough general understanding of computational group theory that it will be possible to work through some examples in what follows. With that in mind, there are three basic ideas that we convey:
1. Stabilizer chains. These underlie the fundamental technique whereby large groups are represented efficiently. They also underlie many of the subsequent computations done using those groups.
2. Coset decompositions. Given a group G and a subgroup H<G, the cosets of H partition G. Each of the cosets can itself be partitioned using a subgroup of H, and so on; this gradual refinement underpins many of the search-based group algorithms that have been developed.
3. Lex-leader search. In general, it is possible to establish a lexicographic ordering on the elements of a permutation group; if we are searching for an element of the group having a particular property (as in the k-transporter problem), we can assume without loss of generality that we are looking for an element that is minimal under this ordering. This often allows the search to be pruned, since any portion of the search that can be shown not to contain such a minimal element can be eliminated.
   3.1 Stabilizer Chains

While the fact that a group G can be described in terms of an exponentially smaller number of generators {gᵢ} is attractive from a representational point of view, there are many issues that arise if a large set of clauses is represented in this way. Perhaps the most fundamental is that of simple membership: How can we tell if a fixed clause c′ is an instance of the augmented clause (c, G)?

In general, this is an instance of the 0-transporter problem; we need some gεG for which g(c), the image of c under 9, does not intersect the complement of c′. A simpler but clearly related problem assumes that we have a fixed permutation g such that g(c)=c′; is gεG or not? Given a representation of G in terms simply of its generators, it is not obvious how this can be determined quickly.

Of course, if G is represented via a list of all of its elements, we could sort the elements lexicographically and use a binary search to determine if g were included. Virtually any problem of interest to us can be solved in time polynomial in the size of the groups involved, but we would like to do better, solving the problems in time polynomial in the number of generators, and therefore polynomial in the logarithm of the size of the groups (and so polylog in the size of the original clausal database). We will call a procedure polynomial only if it is indeed polytime in the number of generators of G and in the size of the set of literals on which G acts. It is only for such polynomial procedures that we can be assured that ZAP's representational efficiencies will mature into computational gains.

For the membership problem, that of determining if gεG given a representation of G in terms of its generators, we need to have a coherent way of understanding the structure of the group G itself. If we suppose that G is a subgroup of the group Sym(L) of symmetries of some set L, we can enumerate the elements of L as L={l₁, . . . , lₙ}.

There will now be some subset of G^{[2]}⊂G that fixes l₁ in that for any hεG^{[2]}, we have h(l₁)=l₁. From this point forward, we will generally use notation that has become popular in the computational group theory community, and write l₁^{h} for the image of l₁ under h, so that the condition in question requires that l₁^{h}=l₁. The reason for the representational shift is that it corresponds naturally to the fact that the composition of two groups elements fg acts with f first and then with g, since f(g(x)) is now written x^{fg}. The fact that g(f(x))=(fg)(x) (note the awkward variable order in this representation) now becomes the natural x^{fg}=(x^{f})^{g} (note the normal variable order).

It is easy to see that G^{[2]} is closed under composition, since if any two elements fix l₁, then so does their composition. It follows that G^{[2]} is actually a subgroup of G. In fact, we have:

Definition 3.1 Given a group G and set L, the pointwise stabilizer of L is the subgroup G′≦G of all gεG such that l⁹=l for every lεL, and will be denoted G_{L}. The set stabilizer of L is that subgroup G′≦G of all gεG such that L^{g}=L, and will be denoted G_{{L}}.

Having defined G^{[2]} as the point stabilizer of l₁, we can go on to define G^{[3]} as the point stabilizer of l₂ within G^{[2]}, so that G^{[3]} is in fact the pointwise stabilizer of {l₁, l₂} in G. Similarly, we define G^{[i+1]} to be the pointwise stabilizer of lᵢ in G^{[i]} and thereby construct a chain of stabilizers
G=G^{[1]}≧G^{[2]}≧ . . . ≧G^{[n]}=1
where the last group is necessarily trivial because once n−1 points of L are stabilized, the last point must be also.

If we want to describe G in terms of its generators, we will now assume that we describe all of the G^{[i]} in terms of generators, and furthermore, that the generators for G^{[i]} are a superset of the generators for G^{[i+1]}. We can do this because G^{[i+1]} is a subgroup of G^{[i]}.

Definition 3.2 A strong generating set S for a group G⊂Sym{l₁, . . . , lₙ} is a set of generators for G with the property that [symbol]
S∩G^{[i]} [symbol] =G^{[i]}
for i=1, . . . , n.

As usual, [symbol] gᵢ [symbol] denotes the group generated by the gᵢ.

It is easy to see that a generating set is strong just in case it has the property discussed above, in that each G^{[i]} can be generated incrementally from G^{[i+1]} and the generators that are in fact elements of G^{[i]}−G^{[i+1]}.

As an example, suppose that G=S₄, the symmetric group on 4 elements (which we will denote 1, 2, 3, 4). Now it is not hard to see that S₄ is generated by the 4-cycle (1, 2, 3, 4) and the transposition (3, 4), but this is not a strong generating set. G^{[2]} is the subgroup of S₄ that stabilizes 1 (and is therefore isomorphic to S₃, since it can randomly permute the remaining three points) but [symbol]
S∩G^{[2]} [symbol] = [symbol] (3,4) [symbol] =G^{[3]}≠G^{[2]} (1)

If we want a strong generating set, we need to add (2, 3, 4) or a similar permutation to the generating set, so that (1) becomes [symbol]
S∩G^{[2]} [symbol] = [symbol] (2,3,4),(3,4) [symbol] =G^{[2]}

Here is a slightly more interesting example. Given a permutation, it is always possible to write that permutation as a composition of transpositions. One possible construction maps 1 where it is supposed to go, then ignores it for the rest of the construction, and so on. Thus we have for example
(1,2,3,4)=(1,2)(1,3)(1,4) (2)
where the order of composition is from left to right, so that 1 maps to 2 by virtue of the first transposition and is then left unaffected by the other two, and so on.

While the representation of a permutation in terms of transpositions is not unique, the parity of the number of transpositions is; a permutation can always be represented as a product of an even or an odd number of transpositions, but not both. Furthermore, the product of two transpositions of lengths l₁ and l₂ can obviously be represented as a product of length l₁+l₂, and it follows that the product of two “even” transpositions is itself even, and we have:

Definition 3.3 The alternating group of order n, to be denoted by Aₙ, is the subgroup of even transpositions of Sₙ.

What about a strong generating set for Aₙ? If we fix the first n−2 points, then the transposition (n−1, n) is obviously odd, so we must have Aₙ^{[n-1]}=1, the trivial group. For any smaller i, we can get a subset of Aₙ by taking the generators for Sₙ^{[i]} and operating on each as necessary with the transposition (n−1, n) to make it even. An n-cycle is odd if and only if n is even (consider (2)), so given the strong generating set
{(n−1,n),(n−2,n−1,n), . . . ,(2,3, . . . ,n),(1,2, . . . ,n)}
for Sₙ, a strong generating set for Aₙ if n is odd is
{(n−2,n−1,n),(n−3,n−2,n−1,n)(n−n), . . . ,(2,3, . . . ,n)(n−1,n),(1,2, . . . , n)}
and if n is even is
{(n−2,n−1,n),(n−3,n−2,n−1,n)(n−1,n), . . . ,(2,3, . . . ,n),(1,2, . . . ,n)(n−1,n)}

We can simplify these expressions slightly to get
{(n−2,n−1,n), −(n−3,n−2,n−1), . . . ,(2,3, . . . ,n−1),(1,2, . . . ,n)}
if n is odd and
{(n−2,n−1,n),(n−3,n−2,n−1), . . . ,(2,3, . . . ,n),(1,2, . . . ,n−1)}
if n is even.

Given a strong generating set, it is possible to compute the size of the original group G. To do this, we need the following well known definition and result:

Definition 3.4 Given groups H≦G and gεG, we define Hg to be the set of all hg for hεH. For any such g, we will say that Hg is a (right) coset of H in G.

Proposition 3.5 Let Hg₁ and Hg₂ be two cosets of H in G. Then |Hg₁|=|Hg₂| and the cosets are either identical or disjoint.

In other words, given a subgroup H of a group G, the cosets of H partition G. This leads to:

Definition 3.6 For groups H≦G, the index of H in G, denoted [G:H], is the number of distinct cosets of H in G.

Corollary 3.7 For a finite group

$$G , [ G : H ] = \frac{\vert G \vert}{\vert H \vert} .$$

Given that the cosets partition the original group G, it is natural to think of them as defining an equivalence relation on G, where x≈y if and only if x and y belong to the same coset of H. We have:

Proposition 3.8 x≈y if and only if xy⁻¹εH.

Many equivalence relations on groups are of this form. So many, in fact, that given an equivalence relation on the elements of a group, it is natural to look for a subgroup H such that the cosets of H define the equivalence relation.

Returning to stabilizer chains, let us denote by lᵢ^{G[i]} the orbit of lᵢ under G^{[i]} (i.e, the set of all points to which G^{[i]} maps lᵢ). We now have:

Proposition 3.9 Given a group G acting on a set {lᵢ} and stabilizer chain G^{[i]},

$$\vert G \vert = {\prod }_{i} \vert {l}_{i}^{{G}^{[ i ]}} \vert \qquad ( 3 )$$

Note that the expression in (3) is easy to compute given a strong generating set. As an example, given the strong generating set {(1, 2, 3, 4), (2, 3, 4), (3, 4)} for S₄, it is clear that S₄^{[3]}= [symbol] (3, 4) [symbol] and the orbit of 3 is of size 2. The orbit of 2 in S₄^{[2]}= [symbol] (2, 3, 4), (3, 4) [symbol] is of size 3, and the orbit of 1 in S₄^{[1]} is of size 4. So the total size of the group is 4!=24.

For A₄, the strong generating set is {(1, 2, 3, 4)(3, 4), (2, 3, 4)}={(1, 2, 3), (2, 3, 4)}. The orbit of 2 in A₄^{[2]}= [symbol] (2, 3, 4) [symbol] is clearly of size 3, and the orbit of 1 in A₄^{[1]}=A₄ is of size 4. So |A₄|=12. In general, there are exactly two cosets of the alternating group because all of the odd permutations can be constructed by multiplying the even permutations in Aₙ by a fixed transposition t. Thus |Aₙ|=n!/2.

We can evaluate the size of Aₙ using strong generators by realizing that the orbit of 1 is of size n, that of 2 is of size n−1, and so on, until the orbit of n−2 is of size 3. The orbit of n−1 is of size 1, however, since the transposition (n−1, n) is not in Aₙ. Thus |Aₙ|=n!/2 as before.

We can also use the strong generating set to test membership in the following way. Suppose that we have a group G described in terms of its strong generating set (and therefore its stabilizer chain G^{[i]}), and a specific permutation w. Now if w(l)=k, there are two possibilities:
1. If k is not in the orbit of 1 in G=G^{[1]}, then clearly w∉G.
2. If k is in the orbit of 1 in G^{[1]}, select g₁εG^{[1]} with 1^{g}^{₁}=g₁(1)=k. Now we construct w₁=wg₁⁻¹, which fixes 1, and we determine recursively if w₁εG^{[2]}.

At the end of the process, we will have stabilized all of the elements moved by G, and should have wₙ₊₁=1. If so, the original wεG; if not, w∉G. This procedure (which we will revisit in Section 4) is known as sifting.

Continuing with our example, let us see if the 4-cycle w=(1, 2, 3, 4) is in S₄ and in A₄. For the former, we see that w(1)=2 and (1, 2, 3, 4)εS₄^{[1]}. This produces w₁=1, and we can stop and conclude that wεS₄.

For the second, we know that (1, 2, 3)εA₄^{[1]} and we get w₁=(1, 2, 3, 4)(1, 2, 3)⁻¹=(3, 4). Now we could actually stop, since (3, 4) is obviously odd, but let us continue with the procedure. Since 2 is fixed by w₁, we have w₂=w₁. Now 3 is moved to 4 by w₂, but A₄^{[3]} is the trivial group, so we conclude correctly that (1, 2, 3, 4)∉A₄.

3.2 Coset Decomposition

Some of the group problems that we will be considering (e.g., the k-transporter problem) subsume what was described previously as subsearch. Subsearch is known to be NP-complete, so it follows that k-transporter must be as well. That suggests that the group-theoretic methods for solving it will involve search in some way.

The search involves a potential examination of all of the instances of some augmented clause (c, G), or, in group theoretic terms, a potential examination of each member of the group G. The computational group theory community often approaches such a search problem by gradually decomposing G into smaller and smaller cosets. What we will call a partition tree is produced, where the root of the tree is the entire group G and the nodes are individual elements of G:

Definition 3.10 Let G be a group, and G^{[i]} a stabilizer chain for it. By the partition tree for G we will mean a tree whose vertices at the ith level are the cosets of G^{[i]} and for which the parent of a particular G^{[i]}g is that coset of G^{[i-1]} that contains it.

At any particular level i, the cosets correspond to the points to which the sequence [symbol] l₁, . . . , lᵢ [symbol] can be mapped, with the points in the image of lᵢ identifying the children of any particular node at level i−1.

As an example, suppose that we consider the augmented clause
(a [symbol] b,Sym(a,b,c,d)) (4)
corresponding to the collection of ground clauses
a [symbol] b
a [symbol] c
a [symbol] d
b [symbol] c
b [symbol] d
c [symbol] d

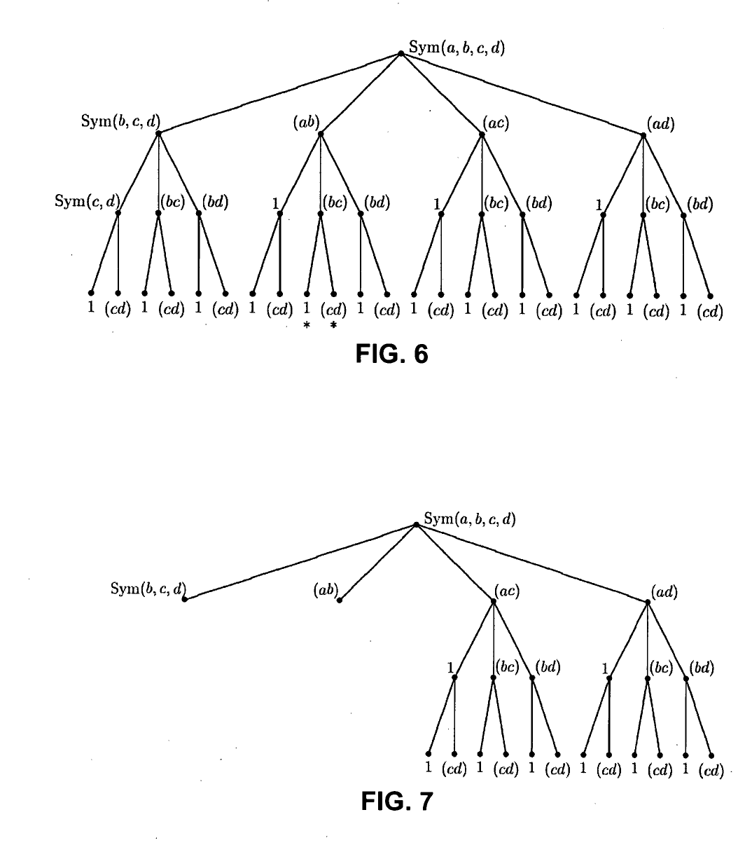

Suppose also that we are working with an assignment for which a and b are true and c and d are false, and are trying to determine if any instance of (4) is unsatisfied. Assuming that we take l₁ to be a through l₄=d, the partition tree associated with S₄ is shown in FIG. 6.

An explanation of the notation in FIG. 6 is in order. The nodes on the lefthand edge are labeled by the associated groups; for example, the node at level 2 is labeled with Sym(b, c, d) because this is the point at which we have fixed a but b, c and d are still allowed to vary.

As we move across the row, we find representatives of the cosets that are being considered. So moving across the second row, the first entry (ab) means that we are taking the coset of the basic group Sym(b, c, d) that is obtained by multiplying each element by (ab) on the right. This is the coset that maps a uniformly to b.

On the lower rows, we multiply the coset representatives associated with the nodes leading to the root. So the third node in the third row, labeled with (bd), corresponds to the coset Sym(c, d)·(bd). The two elements of this coset are (bd) and (cd)(bd)=(bdc). The point b is uniformly mapped to d, a is fixed, and c can either be fixed or mapped to b.

The fourth point on this row corresponds to the coset
Sym(c,d)·(ab)={(ab),(cd)(ab)}
The point a is uniformly mapped to b, and b is uniformly mapped to a. c and d can be swapped or not.

The fifth point is the coset
Sym(c,d)·(bc)(ab)=Sym(c,d)·(abc){(abc),(abcd)} (5)
a is still uniformly mapped to b, and b is now uniformly mapped to c. c can be mapped either to a or to d.

For the fourth line, the basic group is trivial and the single member of the coset can be obtained by multiplying the coset representatives on the path to the root. Thus the ninth and tenth nodes (marked with asterisks in the tree) correspond to the permutations (abc) and (abcd) respectively, and do indeed partition the coset of (5).

Understanding how this structure is used in search is straightforward. At the root, the original augmented clause (4) may indeed have unsatisfiable instances. But when we move to the first child, we know that the image of a is a, so that the instance of the clause in question is a [symbol] x for some x. Since a is true for the assignment in question, it follows that the clause must be satisfied. In a similar way, mapping a to b also must produce a satisfied clause. The search space is already reduced to the structure shown in FIG. 7.

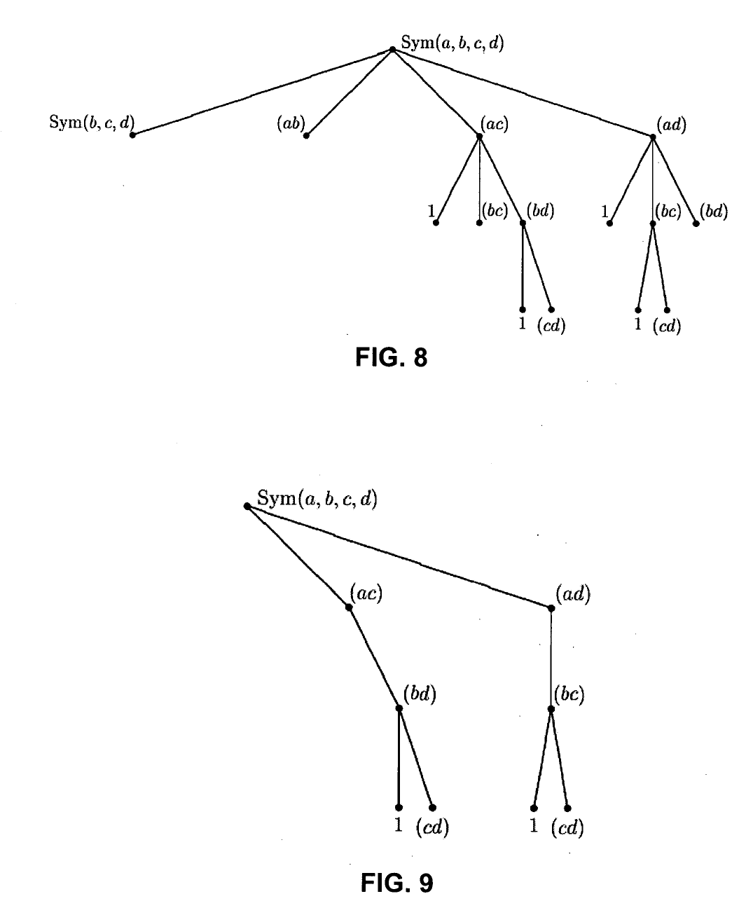

If we map a to c, then the first point on the next row corresponds to mapping b to b, producing a satisfiable clause. If we map b to a (the next node), we also get a satisfiable clause. If we map b to d, we will eventually get an unsatisfiable clause, although it is not clear how to recognize that without expanding the two children. The case where a is mapped to d is similar, and the final search tree is shown in FIG. 8.

Instead of the six clauses that might need to be examined as instances of the original (4), only four leaf nodes need to be considered. The internal nodes that were pruned above can be pruned without generation, since the only values that need to be considered for a are necessarily c and d (the unsatisfied literals in the theory). At some level, then, the above search space becomes as shown in FIG. 9.

3.3 Lex Leaders

Although the remaining search space in this example already examines fewer leaf nodes than the original, there still appears to be some redundancy. To understand one possible simplification, recall that we are searching for a group element g for which g(c) (or, equivalently, c^{g}) is unsatisfied given the current assignment. Since any such group element suffices, we can (if we wish) search for that group element that is smallest under the lexicographic ordering of the group itself. (Where g₁<g₂ if g₁(a) is earlier in the alphabet than g₂ (a) or g₁(a)=g₂ (a) and g₁(b)<g₁(b), and so on.) If we denote by S the set of group elements that have the property we are searching for, the lexicographically smallest element of S is often called the “lexicographic leader” or “lex leader” of S.

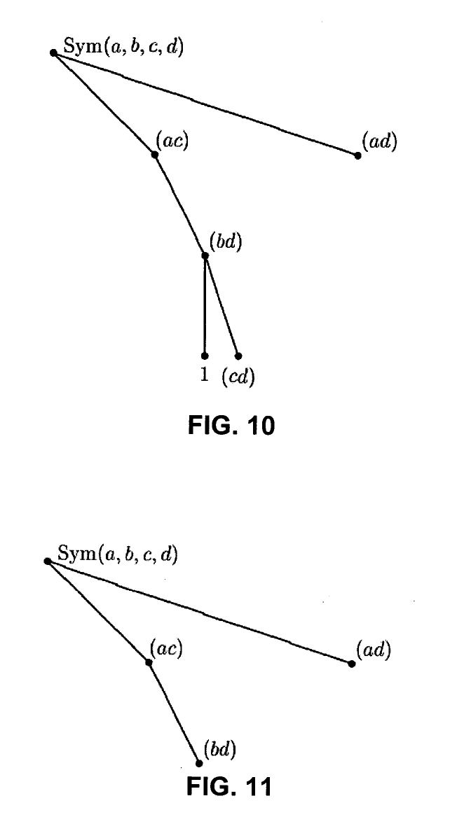

In our example, imagine that there were a solution (i.e., a group element corresponding to an unsatisfied instance) under the right hand node at depth three. Now there would necessarily also have been an analogous solution under the preceding node at depth three, since the two search spaces are in some sense identical. But the group elements under the left hand node precede those under the right hand node in the lexicographic ordering, so it follows that the lexicographically least element (which is all that we're looking for) is not under the right hand node, which can therefore be pruned. The search space becomes as shown in FIG. 10.

This particular technique is quite general: whenever we are searching for a group element with a particular property, we can restrict our search to lex leaders of the set of all such elements and prune the search space on that basis. A more complete discussion in the context of the k-transporter problem specifically can be found in Section 5.5.

Finally, we note that the two remaining leaf nodes are equivalent, since they refer to the same instance—once we know the images of a and of b, the overall instance is fixed and no further choices are relevant. So assuming that the variables in the problem are ordered so that those in the clause are considered first, we can finally prune the search below depth three to get the structure shown in FIG. 11. Only a single leaf node need be considered.

3.4 Stochastic Methods

Finally, we should at least remark on the use of stochastic methods to solve problems in computational group theory. This is an area of considerable current research in the computational group theory community, and some embodiments of our ideas will include the application of stochastic techniques to solve group-theoretic problems.

Essentially, the aim is to replace a deterministic method for computing the solution to a group theoretic problem (such as an instance of the k-transporter problem, or the construction of a stabilizer chain) with a stochastic method that runs more quickly and has a high probability p of returning the correct answer. These techniques are referred to as “Monte Carlo” methods by the computational group theory community, and a variety of such techniques are known and appear in both Seress' book and GAP. Running times for large groups are generally better than for deterministic techniques, and the probabilities of failure are extremely small in practice.

Recent work has focused on the lifting of Monte Carlo methods to so-called Las Vegas methods, which have the property that in some cases, the answer returned is guaranteed to be correct. As an example, an algorithm that returns a candidate solution to the k-transporter problem can check that answer before returning it, so that if a group element is returned, it is guaranteed correct; if the algorithm reports failure, the problem might in fact be solvable after all.

The advantage of Las Vegas methods is that the probability that the answer is correct can generally be increased by running them repeatedly with different random number seeds. In this particular example, we can invoke the procedure repeatedly on a single instance of the k-transporter problem, either stopping when a solution is found or increasing our confidence that no such answer exists. This idea is related to the use of random restarts in combinatorial search generally.

4 Augmented Resolution

We now turn to our ZAP-specific requirements. First, we have the definition of augmented resolution, which involves computing the group of stable extensions of the groups appearing in the resolvents. Specifically, we have augmented clauses (c₁, G₁) and (c₂, G₂) and need to compute the group G of stable extensions of G₁ and G₂. Recalling Definition 2.11, this is the group of all permutations w with the property that there is some g₁εG₁ such that
ω|_{c}_{₁}^{G}^{₁}=g1|_{c}_{₁}^{G}^{₁}
and similarly for G₂ and c₂ (note that we have adjusted notation here, replacing the Gᵢ(cᵢ) in the original definition 2.11 with cᵢ^{G}^{ᵢ}). We are viewing the clauses cᵢ as sets here, with cᵢ^{G}^{ᵢ} as usual being the image of the set under the given permutation group.

As an example, consider the two clauses
(c₁,G₁)=(ab, [symbol] (ad),(be),(bf) [symbol] )
and
(c₂,G₂)=(cb, [symbol] (be),(bg) [symbol] )

The image of c₁ under G₁ is {a, b, d, e, f} and c₂^{G}^{₂}={b, c, e, g}. We therefore need to find a permutation w such that when w is restricted to {a, b, d, e, f}, it is an element of [symbol] (ad), (be), (bf) [symbol] , and when restricted to {b, c, e, g} is an element of [symbol] (be), (bg) [symbol] .

From the second condition, we know that c cannot be moved by w, and any permutation of b, e and g is acceptable because (be) and (bg) generate the symmetric group Sym(b, e, g). This second restriction does not impact the image of a, d or f under W.

From the first condition, we know that a and d can be swapped or left unchanged, and any permutation of b, e and f is acceptable. But recall from the second condition that we must also permute b, e and g. These conditions combine to imply that we cannot move f or g, since to move either would break the condition on the other. We can swap b and e or not, so the group of stable extensions is [symbol] (ad), (be) [symbol] , and that is what our construction should return.

Procedure 4.1 Given augmented clauses (c₁, G₁) and (c₂, G₂), to compute stab(cᵢ, Gᵢ):

| | |
|---|---|
| 1 | c_image₁ [symbol] c₁^{G}^{₁}, c_image₂ [symbol] c₂^{G}^{₂} |
| 2 | g_restrict₁ [symbol] G₁\|_{c}_{_{—}}_{image}_{₁}, g_restrict₂ [symbol] G₂\|_{c}_{_{—}}_{image}_{₂} |
| 3 | C_{∩} [symbol] c_image₁ ∩ c_image₂ |
| 4 | g_stab₁ [symbol] g_restrict_{1{C}_{_{∩}}_{}}, g_stab₂ [symbol] g_restrict_{2{C}_{_{∩}}_{}} |
| 5 | g_int [symbol] g_stab₁\|_{C}_{_{∩}} ∩ g_stab₂\|_{C}_{_{∩}} |
| 6 | {gᵢ} [symbol] {generators of g_int} |
| 7 | {l₁ᵢ} [symbol] {gᵢ, lifted to g_stab₁}, {l₂ᵢ} [symbol] {gᵢ, lifted to g_stab₂} |
| 8 | {l′₂ᵢ} [symbol] {l₂ᵢ\|_{c}_{_{—}}_{image}_{₂}_{-C}_{_{∩}}_{}} |
| 9 | return <g_restrict_{1C}_{_{∩}}, g_restrict_{2C}_{_{∩}}, {l₁ᵢ · l′₂ᵢ}> |

Proposition 4.2 The result returned by Procedure 4.1 is stab(cᵢ, Gᵢ).

Let us present an example of the computation in use. We will then present the proof and discuss the computational issues surrounding Procedure 4.1. The example we will use is that with which we began this section, but we modify G₁ to be [symbol] (ad), (be), (bf), (xy) [symbol] instead of the earlier [symbol] (ad), (be), (bf) [symbol] . The new points x and y don't affect the set of instances in any way, and thus should not affect the resolution computation, either.
1. c_imageᵢ←c₁^{G}^{₁}. This amounts to computing the images of the cᵢ under the Gᵢ; as described earlier, we have c_image₁={a, b, d, e, f} and c_image₂={b, c, e, g}.
2. g_restrictᵢ←Gᵢ|_{c}_{_{—}}_{image}_{ᵢ}. Here, we restrict each group to act only on the corresponding c_imageᵢ. In this example, g_restrict₂=G₂ but g_restrict₁= [symbol] (ad), (be), (bf) [symbol] as the irrelevant points x and y are removed.
   Note that it is not always possible to restrict a group to an arbitrary set; one cannot restrict the permutation (xy) to the set {x} because you need to add y as well. But in this case, it is possible to restrict Gᵢ to c_imageᵢ, since this latter set is closed under the action of the group.
3. C_{∩}←c_image₁∩c_image₂. The construction itself works by considering three separate sets—the intersection of the images of the two original clauses (where the computation is interesting because the various w must agree), and the points in only the image of c₁ or only the image of c₂. The analysis on these latter sets is straightforward; we just need w to agree with any element of G₁ or G₂ on the set in question.
   In this step, we compute the intersection region C_{∩}. In our example, C_{∩=}{b, e}.
4. g_stabᵢ←g_restrict_{i{C}_{^{∩}}_{}}. We find the subgroup of g_restrictᵢ that set stabilizes C_{∩}, in this case the subgroup that set stabilizes the pair {b, e}. For gₗrestrict₁= [symbol] (ad), (be), (bf) [symbol] , this is [symbol] (ad), (be) [symbol] because we can no longer swap b and f, while for g_restrict₂= [symbol] (be), (bg) [symbol] , we get g_stab₂= [symbol] (be) [symbol] .
5. g_int←g_stab₁|_{C}_{_{∩}}∩g_stab₂|_{C}_{_{∩}}. Since w must simultaneously agree with both G₁ and G₂ when restricted to C_{∩} (and thus with g_restrict₁ and g_restrict₂ as well), the restriction of w to C_{∩} must lie within this intersection. In our example, g_int= [symbol] (be) [symbol] .
6. {gᵢ}←{generators of g_int}. Any element of g_int will lead to an element of the group of stable extensions provided that we extend it appropriately from C_{∩} back to the full set c₁^{G}^{₁}∩c₂^{G}^{₂}; this step begins the process of building up these extensions. It suffices to work with just the generators of g_int, and we construct those generators here. We have {gᵢ}={(be)}.
7. {lₖᵢ}←{gᵢ, lifted to g_stabₖ}. Our goal is now to build up a permutation on c_image₁∪c_image₂ that, when restricted to C_{∩}, matches the generator gᵢ. We do this by lifting gᵢ separately to c_image, and to c_image₂. Any such lifting suffices, so we can take (for example)
   l₁₁=(be)(ad)
   and
   l₂₁=(be)
   In the first case, the inclusion of the swap of a and d is neither precluded nor required; we could just as well have used l₁₁=(be).
8. {l₂ᵢ′}←{l₂ᵢ|_{c}_{_{—}}_{image}_{_{2−C}}_{_{∩}}}. We cannot simply compose l₁₁ and l₂₁ to get the desired permutation on c_image₁∪c_image₂ because the part of the permutations acting on the intersection c_image₁∩c_image₂ will have acted twice. In this case, we would get l₁₁·l₂₁=(ad) which no longer captures our freedom to exchange b and e.

We deal with this by restricting l₂₁ away from Cn and only then combining with l₁₁. In the example, restricting (be) away from C_{∩}={b, e} produces the trivial permutation l₂₁′=( ).
9. Return [symbol] g_restrict_{1C}_{_{∩}}, g_restrict_{2C}_{_{∩}}, {l₁ᵢ·l₂ᵢ′} [symbol] . We now compute the final answer from three sources: The combined l₁ᵢ·l₂ᵢ′ that we have been working to construct, along with elements of g_restrict₁ that fix every point in the image of c₂ and elements of g_restrict₂ that fix every point in the image of c₁. These latter two sets consist of stable extensions. An element of g_restrict₁ pointwise stabilizes the image of c₂ if and only if it pointwise stabilizes the points that are in both the image of c₁ (to which g_restrict₁ has been restricted) and the image of c₂; in other words, if and only if it pointwise stabilizes C_{∩}.

In our example, we have
g_{—}restrict_{1C}_{_{∩}}= [symbol] (ad) [symbol]
g_{—}restrict_{2C}_{_{∩}}=1
{l₁ᵢ·l₂ᵢ′}={(be)(ad)}
so that the final group returned is [symbol]
(ad),(be)(ad)

[symbol]

This group is identical to [symbol]
(ad),(be)

[symbol]

We can swap either the (a, d) pair or the (b, e) pair, as we see fit. The first swap (ad) is sanctioned for the first “resolvent” (c₁, G₁)=(a [symbol] b, [symbol] (ad), (be), (bf) [symbol] ) and does not mention any relevant variable in the second (c₂, G₂)=(c [symbol] b, [symbol] (be), (bg) [symbol] ). The second swap (be) is sanctioned in both cases.

Proposition 4.2 The result returned by Procedure 4.1 is stab(cᵢ, Gᵢ).

Computational issues We conclude this section by discussing some of the computational issues that arise when we implement Procedure 4.1, including the complexity of the various operations required.
1. c_imageᵢ←cᵢ^{G}^{ᵢ}. Efficient algorithms exist for computing the image of a set under a group. The basic method is to use a flood-fill like approach, adding and marking the result of acting on the set with a single element, and recurring until no new points are added.
2. g_restrictᵢ←Gᵢ|_{c}_{_{—}}_{image}_{ᵢ}. A group can be restricted to a set that it stabilizes by restricting the generating permutations individually.
3. C_{∩}←c_image₁∩c_image₂. Set intersection is straightforward.
4. g_stabᵢ←g_restrict_{i{C}_{_{∩}}}. Set stabilizer is not straightforward, and is not known to be polynomial in the number of generators of the group being considered. The most effective implementations work with a coset decomposition as described in Section 3.2; in computing G_{{S}} for some set S, a node can be pruned when it maps a point inside of S out of S or vice versa. GAP implements this.
5. g_int←g_stab₁|_{C}_{_{∩}}∩g_stab₂|_{C}_{_{∩}}. Group intersection is also not known to be polynomial in the number of generators; once again, a coset decomposition is used. Coset decompositions are constructed for each of the groups being combined, and the search spaces are pruned accordingly. GAP implements this as well.
6. {gᵢ}←{generators of g_int}. Groups are typically represented in terms of their generators, so reconstructing a list of those generators is trivial. Even if the generators are not known, constructing a strong generating set is known to be polynomial in the number of generators constructed.
7. {lₖᵢ}←{gᵢ, lifted to g_stabₖ}. Suppose that we have a group G acting on a set T, a subset V⊂T and a permutation h acting on V such that we know that h is the restriction to V of some gεG, so that h=g|_{V}. To find such a g, we first construct a stabilizer chain for G where the ordering used puts the elements of T−V first. Now we are basically looking for a gεG such that the sifting procedure of Section 3.1 produces h at the point that the points in T−V have all been fixed. We can find such an g in polynomial time by inverting the sifting procedure itself.
8. {l₂ᵢ′}←{₂ᵢ|_{c}_{_{—}}_{image}_{₂}_{-c}_{_{∩}}}. As in line 2, restriction is still easy.
9. Return [symbol] g_restrict_{1C}_{_{∩}}, g_restrict_{2C}_{_{∩}}, {l₁ᵢ·l₂ᵢ′}). Since groups are typically represented by their generators, we need simply take the union of the generators for the three arguments. Pointwise stabilizers (needed for the first two arguments) are straightforward to compute using stabilizer chains.

5 Unit Propagation and the (Ir)Relevance Test

As we have remarked, the other main computational requirement of an augmented satisfiability engine is the ability to solve the k-transporter problem: Given an augmented clause (c, G) where c is once again viewed as a set of literals, and sets S and U of literals and an integer k, we want to find a gεG such that c^{g}∩S=Ø and |c^{g}∩U|≦k, if such a g exists. (Once again, we have changed to the notation where group elements are written as exponents of the objects on which they are acting.)

5.1 A Warmup

We begin with a somewhat simpler problem, assuming that U=0 so we are simply looking for a g such that c^{g}∩S=Ø.

We need the following definition:

Definition 5.1 Let H≦G be groups. By a transversal of H in G we will mean any subset of G that contains one element of each coset of H. We will denote such a transversal by G/H.

Note that since H itself is one of the cosets, the transversal must contain a (unique) element of H. We will generally assume that the identity is this unique element.

Procedure 5.2 Given groups H≦G, an element tεG, sets c and S, to find a group element g=map(G, H, t, c, S) with gεH and c^{gt}∩S=Ø:

| | |
|---|---|
| 1 | F [symbol] {α ∈ c such that α is fixed by H} |
| 2 | if F^{t} ∩ S ≠ Ø |
| 3 | then return FAILURE |
| 4 | if c ⊂ F |
| 5 | then return 1 |
| 6 | α [symbol] an element of c - F |
| 7 | for each t′ in H/H_{α} |
| 8 | do r [symbol] map(G, H_{α}, t′t, c, S) |
| 9 | if r ≠ FAILURE |
| 10 | then return rt′ |
| 11 | return FAILURE |

This is essentially a codification of the example that was presented in Section 3.2. We terminate the search when the clause is fixed by the remaining group H, but have not yet included any analog to the lex-leader pruning that we discussed in Section 3.3. In the recursive call in line 8, we retain the original group, for which we will have use in subsequent versions of the procedure.

Proposition 5.3 map(G, G, 1, c, S) returns an element gεG for which c^{g}∩S=Ø, if such an element exists, and returns FAILURE otherwise.

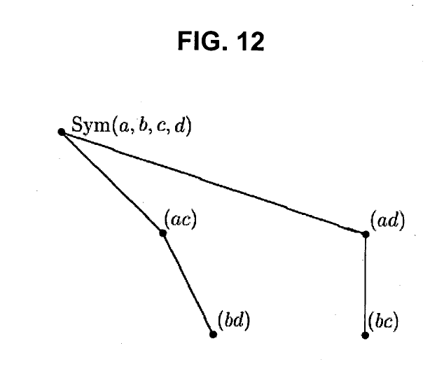

Given that the procedure terminates the search when all elements of c are stabilized by G but does not include lex-leader considerations, the search space examined in the example from Section 3.2 is as shown by the structure in FIG. 12. It is still important to prune the node in the lower right, since for a larger problem, this node may be expanded into a significant search subtree. We discuss this pruning in Section 5.5.

In the interests of clarity, let us go through the example explicitly. Recall that the clause c=x₁ [symbol] x₂, G=Sym(x₁, x₂, x₃, x₄) permutes the xᵢ arbitrarily, and that S={x₁, x₂}.

On the initial pass through the procedure, F=Ø; suppose that we select x₁ to stabilize first. Step 7 now selects the point to which x₁ should be mapped; if we select x₁ or x₂, then x₁ itself will be mapped into S and the recursive call will fail on line 3. So suppose we pick x₃ as the image of x₁.

Now F={x₁}, and we need to fix the image of another point; x₂ is all that's left in the original clause c. As before, selecting x₁ or x₂ as the image of x₂ leads to failure. x₃ is already taken (it's the image of x₁), so we have to map x₂ into x₄. Now every element of c is fixed, and the next recursive call returns the trivial permutation on line 5. This is combined with (x₂x₄) on line 10 in the caller as we fix x₄ as the image of x₂. The original invocation then combines with (x₁x₃) to produce the final answer of (x₁x₃)(x₂x₄).

5.2 The k-Transporter Problem

Extending the above algorithm to solve the k-transporter problem is straightforward; in addition to requiring that F^{t}∩S=Ø in line 3, we also need to keep track of the number of points that have been mapped into the set U and make sure that we haven't exceeded the limit k:

Procedure 5.4 Given groups H≦G, an element tεG, sets c, S and U and an integer k, to find a group element g=transport (G, H, t, c, S, U, k) with gεH, c^{gt}∩S=Ø and |c^{gt}∩U|≦k:

| | |
|---|---|
| 1 | F [symbol] {α ∈ c such that α is fixed by H} |
| 2 | if F^{t} ∩ S ≠ Ø |
| 3 | then return FAILURE |
| 4 | if \|F^{t} ∩ U\| > k |
| 5 | then return FAILURE |
| 6 | if c ⊂ F |
| 7 | then return 1 |
| 8 | α [symbol] an element of c - F |
| 9 | for each t′ in H/H_{α} |
| 10 | do r [symbol] transport(G, H_{α}, t′t, c, S, U, k) |
| 11 | if r ≠ FAILURE |
| 12 | then return rt′ |
| 13 | return FAILURE |

Proposition 5.5 transport (G, G, 1, c, S, U, k) returns an element gεG for which c^{g}∩S=Ø and |c^{g}∩U|≦k, if such an element exists, and returns FAILURE otherwise.

The procedure is simplified significantly by the fact that we only need to return a single g with the desired properties, as opposed to all of them. But it might seem that it would be more efficient, when looking for unit instances of (c, G), to return all such instances as opposed to only one.

This is not the case. If a single unit instance is found, setting the unvalued literal it contains may well cause (c, G) to acquire new unit instances, and the search will therefore need to be repeated in any event.

In what follows, we will investigate a variety of techniques that generalize the prune at lines 4-5 of Procedure 5.4. It will therefore be convenient to rewrite the procedure as:

Procedure 5.6 Given groups H≦G, an element tεG, sets c, S and U and an integer k, to find a group element g=transport (G, H, t, c, S, U, k) with gεH, c^{gt}∩S=Ø and |c^{gt}∩U|≦k:

| | |
|---|---|
| 1 | F [symbol] {α ∈ c such that α is fixed by H} |
| 2 | if F^{t} ∩ S ≠ Ø |
| 3 | then return FAILURE |
| 4 | if overlap(H,c, (S ∪ U)^{t}⁻¹) > k |
| 5 | then return FAILURE |
| 6 | if c ⊂ F |
| 7 | then return 1 |
| 8 | α [symbol] an element of c - F |
| 9 | for each t′ in H/H_{α} |
| 10 | do r [symbol] transport(G, H_{α}, t′t, c, S, U, k) |
| 11 | if r ≠ FAILURE |
| 12 | then return rt′ |
| 13 | return FAILURE |

In line 4, we use an auxiliary function that determines the minimum overlap between c^{g} and (S∩U)^{t}^{^{−1}}. Our initial version of overlap is:

Procedure 5.7 Given a group H, and two sets c, V, to compute overlap(H, c, V), a lower bound on the overlap of c^{h} and V for any hεH:
1 F←{αεc such that a is fixed by H}
2 return |F∩V|

Proposition 5.8 transport(G, G, 1, c, S, U, k) as computed by Procedure 5.6 returns an element gεG for which c^{g}∩S=Ø and |c^{g}∩U|≦k, if such an element exists, and returns FAILURE otherwise.

5.3 Orbit Pruning

There are two general ways in which nodes can be pruned in the k-transporter problem. Lexicographic pruning is a bit more difficult, so we defer it until Section 5.5. To understand the other, consider the following example.

Suppose that c=x₁ [symbol] x₂ [symbol] x₃ and that the group G permutes the variables {x₁, x₂, x₃, x₄, x₅, x₆} arbitrarily. If S={x₁, x₂, x₃, x₄}, is there a gεG with c^{g}∩S=Ø?

Clearly not; there isn't enough “room” because the image of c will be of size three, and there is no way that this 3-element set can avoid the 4-element set S in the 6-element universe {x₁, x₂, x₃, x₄, x₅, x₆}.

We can do a bit better in many cases. Suppose that our group G is [symbol] (x₁x₄), (x₂x₅), (x₃x₆) [symbol] so that we can swap x₁ with x₄ (or not), x₂ with x₅, or x₃ with x₆. Now if S={x₁, x₄}, can we find a gεG with c^{g}∩S=Ø?

Once again, the answer is clearly no. The “orbit” of x₁ in G is {x₁,x₄} and since {x₁,x₄}⊂S, x₁'s image cannot avoid the set S.

To formalize this, we first define an orbit:

Definition 5.9 Let G be a group acting on a set T. Then an orbit of G is a minimal subset V of T that is closed under G, so that V^{G}=V. For a specific element xεT, the orbit of x is the orbit of G that contains x.

Consider now the initial call, where t=1, the identity permutation. Given the group G, consider the orbits of the points in c. If there is any such orbit W for which |W∩c|>|W−S|, we can prune the search. The reason is that each of the points in W∩c must remain in W when acted on by any element of G; that is what the definition of an orbit requires. But there are too many points in W∩c to stay away from S, so we will not manage to have c^{g}∩S=Ø.

What about the more general case, where t≠1 necessarily? For a fixed α in our clause c, we will construct the image α^{tg}, acting on α first with g and then with t. We are interested in whether α^{gt}εS or, equivalently, if α^{g}εS^{t}^{^{−1}}. Now α^{g} is necessarily in the same orbit as α, so we can prune if
|W∩c|>|W−S^{t}^{^{−1}}|

For similar reasons, we can also prune if
|W∩c|>|W−U^{t}^{^{−1}}|+k

In fact, we can prune if
|W∩c|>|W−(S∪U)^{t}^{^{−1}}|+k
because there still is not enough space to fit the image without either intersecting S or putting at least k points into U.

We can do better still. As we have seen, for any particular orbit, the number of points that will eventually be mapped into U is at least
|W∩c|−|W−(S∪U)^{t}^{^{−1}}|

In some cases, this expression will be negative; the number of points that will be mapped into U is at least
max(|W∩c|−|W−(S∪U)^{t}^{^{−1}}|, 0)
and we can prune any node for which

$${\sum }_{W} max ( \vert W ⋂ c \vert - \vert W - {( S ⋃ U )}^{t - 1} \vert , 0 ) > k \qquad ( 6 )$$

where the sum is over the orbits of the group.

It will be somewhat more convenient to rewrite this using the fact that
|W∩c|+|W−c|=|W|=|w∩(S∪U)^{t}^{^{−1}}|+|W−(S∪U)^{t}^{^{−1}}|.
so that (6) becomes

$${\sum }_{W} max ( \vert W ⋂ {( S ⋃ U )}^{{t}^{- 1}} \vert - \vert W - c \vert , 0 ) > k \qquad ( 7 )$$

Incorporating this into Procedure 5.7 gives:

Procedure 5.10 Given a group H, and two sets c, V, to compute overlap (H, c, V), a lower bound on the overlap of c^{h} and V for any hεH:

| | |
|---|---|
| 1 | m [symbol] 0 |
| 2 | for each orbit W of H |
| 3 | do m [symbol] m + max(\|W ∩ V\| − \|W − c\|, 0) |
| 4 | return m |

Proposition 5.11 Let H be a group and c, V sets acted on by H. Then for any hεH, |c^{h}∩V|≧overlap(H, c, V) where overlap is computed by Procedure 5.10.

5.4 Block Pruning

The pruning described in the previous section can be improved further. To see why, consider the following example, which might arise in solving an instance of the pigeonhole problem. We have the two cardinality constraints:
x₁+x₂+x₃+x₄≧2 (8)
x₅+x₆+x₇+x₈≧2 (9)
presumably saying that at least two of four pigeons are not in hole m and at least two are not in hole n for some m and n. (In an actual pigeonhole instance, all of the variables would be negated. We have dropped the negations for convenience.) Rewriting the individual cardinality constraints as augmented clauses produces
(x₁ [symbol] x₂ [symbol] x₃,Sym(x₁,x₂,x₃,x₄))
(x₅ [symbol] x₆ [symbol] x₇,Sym(x₅,x₆,x₇,x₈))
or, in terms of generators,
(x₁ [symbol] x₂ [symbol] x₃, [symbol] (x₁x₂),(x₂x₃x₄) [symbol] ) (10)
(x₅ [symbol] x₆ [symbol] x₇, [symbol] (x₅x₆),(x₆x₇x₈) [symbol] ) (11)

What we would really like to do, however, is to capture the full symmetry in a single axiom.

We can do this by realizing that we can obtain (11) from (10) by switching x₁ and x₅, x₂ and x₆, and x₃ and x₇ (in which case we want to switch x₄ and x₈ as well). So we add the generator (x₁x₅)(x₂x₆)(x₃x₇)(x₄x₈) to the overall group, and modify the permutations (x₁x₂) and (x₂x₃x₄) (which generate Sym(x₁, x₂, x₃, x₄)) so that they permute x₅, x₆, x₇, x₈ appropriately as well. The single augmented clause that we obtain is
(x₁ [symbol] x₂ [symbol] x₃, [symbol] (x₁x₂)(x₅x₆),(x₂x₃x₄)(x₆x₇x₈), (x₁x₅)(x₂x₆)(x₃x₇)(x₄x₈) [symbol] ) (12)
and it is not hard to see that this does indeed capture both (10) and (11).

Now suppose that x₁ and x₅ are false, and the other variables are unvalued. Does (12) have a unit instance?

With regard to the pruning condition in the previous section, the group has a single orbit, and the condition (with t=1) is
|W∩(S∪U)|−|W−c|>1 (13)

But
W={x₁,x₂,x₃,x₄,x₅,x₆,x₇,x₈}
S=Ø
U={x₂,x₃,x₄,x₆,x₇,x₈}
c={x₁,x₂,x₃}
so that |W∩(S∪U)|=6, |W−c|=5 and (13) fails.

But it should be possible to conclude immediately that there are no unit instances of (12). After all, there are no unit instances of (8) or (9) because only one variable in each clause has been set, and three unvalued variables remain. Equivalently, there is no unit instance of (10) because only one of {x₁, x₂, x₃, x₄} has been valued, and two need to be valued to make x₁ [symbol] x₂ [symbol] x₃ or another instance unit. Similarly, there is no unit instance of (11). What went wrong?

What went wrong is that the pruning heuristic thinks that both x₁ and x₅ can be mapped to the same clause instance, in which case it is indeed possible that the instance in question be unit. The heuristic doesn't realize that x₁ and x₅ are in separate “blocks” under the action of the group in question.

To formalize this, let us first make the following definition:

Definition 5.12 Let T be a set, and G a group acting on it. We will say that G acts transitively on T if T is an orbit of G.

Put somewhat differently, G acts transitively on T just in case for any x, yεT there is some gεG such that x⁹=y.

Definition 5.13 Suppose that a group G acts transitively on a set T. Then a block system for G is a partitioning of T into sets B₁, . . . , Bₙ such that G permutes the Bᵢ.

In other words, for each gεG and each block Bᵢ, Bᵢ^{g}=Bⱼ for some j; the image of Bᵢ under g is either identical to it (if j=i) or disjoint (if j≠i, since the blocks partition T).

Every group acting transitively and nontrivially on a set T has at least two block systems:

Definition 5.14 For a group G acting transitively on a set T, a block system B₁, . . . , Bₙ will be called trivial if either n=1 or n=|T|.

In the former case, there is a single block consisting of the entire set T (which obviously is a block system). If n=|T|, each point is in its own block; since G permutes the points, it obviously permutes the blocks.

Lemma 5.15 All of the blocks in a block system are of identical size.

In the example we have been considering, B₁={x₁, x₂, x₃, x₄} and B₂={x₅, x₆, x₇, x₈} is also a block system for the action of the group on the set T={x₁, x₂, x₃, x₄, x₅, x₆, x₇, x₈}. And while it is conceivable that a clause is unit within the overall set T, it is impossible for it to have fewer than two unvalued literals within each particular block. Instead of looking at the overall expression
|W∩(S∪U)|−|W−c|>1 (14)
we can work with individual blocks.

The clause x₁ [symbol] x₂ [symbol] x₃ is in a single block in this block system, and will therefore remain in a single block after being acted on with any gεG. If the clause winds up in block Bᵢ, then the condition (14) can be replaced with
|Bᵢ∩(S∪U)|−|Bᵢ−c|>1
or, in this case,
|Bᵢ∩(S∪U)|>|Bᵢ−c|+1=2
so that we can prune if there are more than two unvalued literals in the block in question. After all, if there are three or more unvalued literals, there must be at least two in the clause instance being considered, and it cannot be unit.

Of course, we don't know exactly which block will eventually contain the image of c, but we can still prune if
min(|Bᵢ∩(S∪U)|)>2
since in this case any target block will generate a prune. And in the example that we have been considering,
|Bᵢ∩(S∪U)|=3
for each block in the block system.

Generalizing this idea is straightforward. For notational convenience, we introduce:

Definition 5.16 Let T={Tᵢ} be sets, and suppose that Tᵢ_{₁}, . . . , Tᵢ_{ₙ} are the n elements of T of smallest size. Then we will denote Σⱼ₌₁ⁿ|Tᵢ_{ⱼ}| by min₊ₙ{Tᵢ}.

Proposition 5.17 Let G be a group acting transitively on a set T, and let c, V⊂T. Suppose also that {Bᵢ} is a block system for G and that c∩Bᵢ≠Ø for n of the blocks in {Bᵢ}. Then if b is the size of an individual block Bᵢ and gεG,
|c^{g}∩V|≧|c|+min₊ₙ{Bᵢ∩V}−nb (15)

Proposition 5.18 If the block system is trivial (in either sense), (15) is equivalent to
|c^{g}∩V|≧|T∩V|−|T−c| (16)

Proposition 5.19 Let {Bᵢ} be a block system for a group G acting transitively on a set T. Then (15) is never weaker than (16).

In any event, we have shown that we can strengthen Procedure 5.10 to:

Procedure 5.20 Given a group H, and two sets c, V, to compute overlap(H, c, V), a lower bound on the overlap of c^{h} and V for any hεH:

| | |
|---|---|
| 1 | m [symbol] 0 |
| 2 | for each orbit W of H |
| 3 | do {Bᵢ} [symbol] a block system for W under H |
| 4 | n = \|{i\|Bᵢ ∩ c ≠ Ø}\| |
| 5 | m [symbol] m + max(\|c\|+ min₊ₙ{Bᵢ ∩ V} − n\|B₁\|, 0) |
| 6 | return m |

In practice, the best choice of a block system for line 3 of the procedure appears to be a minimal block system (i.e., one with blocks of the smallest size) for which c is contained within a single block. Now Procedure 5.20 becomes:

Procedure 5.21 Given a group H, and two sets c, V, to compute overlap(H, C, V), a lower bound on the overlap of c^{h} and V for any hεH:

| | |
|---|---|
| 1 | m [symbol] 0 |
| 2 | for each orbit W of H |
| 3 | do {Bᵢ} [symbol] a minimal block system for W under H for which |
| | c ⊂ Bᵢ for some i |
| 4 | m [symbol] m + max(\|c\| + min(Bᵢ ∩ V) − \|B₁\|, 0) |
| 5 | return m |

Proposition 5.22 Let H be a group and c, V sets acted on by H. Then for any hεH, |c^{h}∩V|≧overlap(H, c, V) where overlap is computed by Procedure 5.21.

Note that the block system being used depends only on the group H and the original clause c. This means that in an implementation it is possible to compute these block systems once and then use them even if there are changes in the sets S and U of satisfied and unvalued literals respectively.

GAP includes algorithms for finding minimal block systems for which a given set of elements (called a “seed” in GAP) is contained within a single block. The basic idea is to form an initial block “system” where the points in the seed are in one block and each point outside of the seed is in a block of its own. The algorithm then repeatedly runs through the generators of the group, seeing if any generator g maps elements x, y in one block to x^{g} and y^{g} that are in different blocks. If this happens, the blocks containing x^{g} and y^{g} are merged. This continues until every generator respects the candidate block system, at which point the procedure is complete.

5.5 Lexicographic Pruning

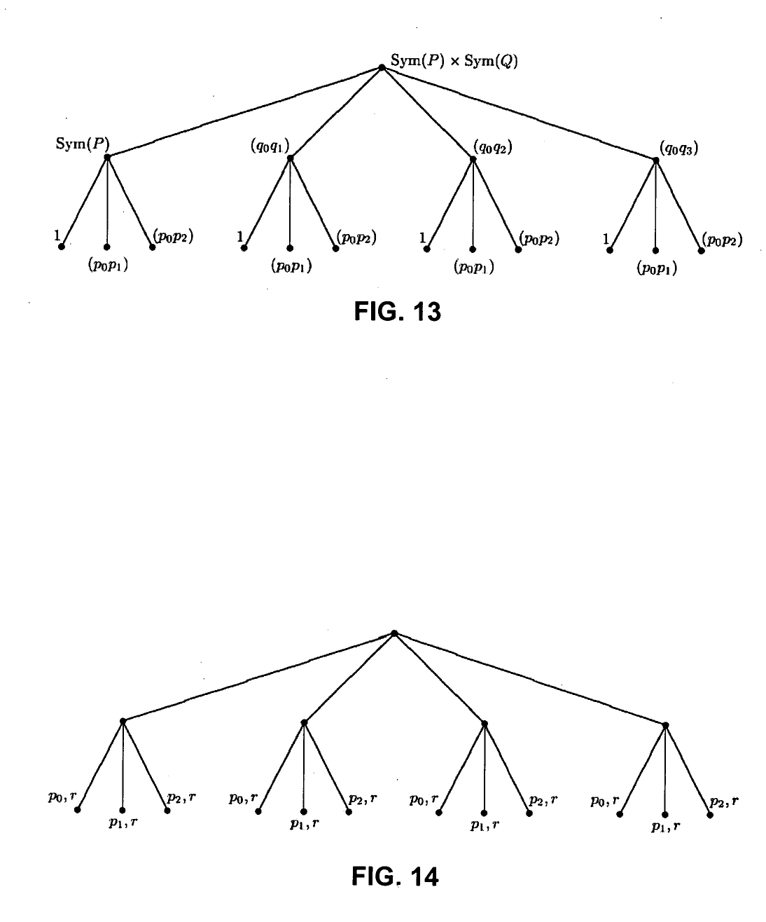

Block pruning, however, will not help us with the example at the end of Section 5.1. The final space being searched is illustrated by FIG. 13. As we have remarked, the first fringe node (where a is mapped to c and b to d) is essentially identical to the second (where a is mapped to d and b to c). It is important not to expand both since more complicated examples may involve a substantial amount of search below the nodes that are fringe nodes in the above figure.

This is the sort of situation in which lexicographic pruning can generally be applied. We want to identify the two fringe nodes as equivalent in some way, and then expand only the lexicographically least member of each equivalence class. For any particular node n, we need a computationally effective way of determining if n is the lexicographically least member of its equivalence class.

We begin by identifying conditions under which two nodes are equivalent. To lift the problem to a more general (and more easily described) setting, suppose that we have a group G acting on a set T. We have a Boolean function b:P(T)→{true,false} that takes a subset V⊂T (an element of P(T), the power set of T) and returns true if V meets some (otherwise unspecified) condition and false if V does not meet the condition. Given a fixed subset c⊂T, we want to use coset decomposition to find a gεG such that b(c^{g}) is true, if such a gεG exists. As the search proceeds, under what conditions are two nodes n and n′ equivalent?

We assume first that the nodes are both at the same depth d in the search tree, and that the points that have been stabilized in getting to this depth are α={a₁, . . . , α_{d}}. For each node, the residual group to be expanded is G_{α}, but there are different coset representatives t and t′ leading from the root of the tree to n and n′ respectively.

The fringe nodes under n correspond to group elements gt for the various gεG_{α}, and those under n′ correspond to gt′. In order for the two nodes to be equivalent, we need for the set of gt to be equivalent to the set of gt′ when acting on the set c. In other words, for any gεG_{α}, we need there to exist a g′εG_{α} such that c^{gt}=c^{g′t′}.

While this does indeed define an equivalence relation, it is not one that we are able to compute effectively. So instead of requiring that the fringe nodes under n′ be a permutation of those under n, we make the more restrictive requirement that they match exactly, so that
c^{gt}=c^{gt′} (17)
for any gεG_{α}.

In fact, we will be more restrictive still. Let β denote the set of elements of T that are fixed by G_{α}. (Obviously α⊂β, but the inclusion need not be proper if fixing some αᵢ also fixes other elements of the set T.) Instead of requiring that c^{gt}=c^{gt′} for the clause in its entirety, we require that the portions of c that are fixed or not fixed by G_{α} match up. In other words, we require that (c∩β)^{gt}=(c∩β)^{gt′} (18)

and
(c−β)^{gt}=(c−β)^{gt′} (19)

These two conditions obviously suffice to ensure that n and n′ are equivalent.

Consider (18) first. Since G_{α} point stabilizes β, it follows that (c∩β)^{g}=c∩β, and the condition becomes
(c∩β)^{t}=(c∩β)^{t′}

We rewrite this as
(c∩β)^{tt′}^{^{−1}}=c∩β
or, equivalently,
tt′⁻¹εG_{{c∩β}} (20)
saying that tt′⁻¹ is in the set stabilizer of c∩β. Note that (20) simply says that t and t′ are in the same coset of G_{{c∩β}}.

The second condition will require a bit more work. We begin by rewriting (19) as
(c−β)^{gtt′}^{^{−1}}=(c−β)^{g} (21)

This is an instance of the following:

Definition 5.23 Let G be a group acting on a set T, and suppose that H≦G and V⊂T. We will say that gεG is (V, H)-transparent if for any hεH, V^{hg}=V^{h}. If V and H are obvious from context, we will simply say that g is transparent. The set of all (V,H)-transparent elements of G will be denoted G_{V,H}.

Lemma 5.24 G_{v,H}≦G.

In other words, the set of transparent elements is a subgroup of G.

Our requirement (21) is now clearly equivalent to the requirement that tt′⁻¹ be (c−β, G_{α})-transparent. But G_{α}=G_{β}, since they are both the point stabilizers of β. Putting together all of the pieces, we have shown:

Proposition 5.25 Let G be a group acting on a set T, and suppose that b is a Boolean function on the subsets of T. Fix c⊂T and β⊂T. For t, t′εG, suppose that
tt′⁻¹εG_{{c∩β}}∩G_{c-β,G}_{_{β}} (22)

Then there will be a gεG_{β}t for which b(c^{g}) is true if and only if there is a g′εG_{β}t′ for which b(c^{g′}) is true.

In other words, the search nodes corresponding to t and to t′ are equivalent.

Note that the intersection on the righthand side of (22) is the intersection of two subgroups of G, and is itself therefore a subgroup of G. If we denote this subgroup by Z, the equivalence condition of the proposition is simply that t and t′ be in the same coset of Z.

In order to use this idea in practice, we need to be able to do the following:
1. Compute G_{{c∩β}},
2. Compute G_{c-β,G}_{_{β}},
3. Compute the intersection G_{{c∩β}}∩G_{c-β,G}_{_{β}}, and
4. Determine if a specific t will be pruned by some other t′.

The first of these tasks is a set stabilizer calculation and the third task is a group intersection. Both of these are described above. The second and fourth tasks are described below.

To compute the transparent elements, we have the following:

Procedure 5.26 Given a finite group G acting on a set T, a subgroup H=( [symbol] ᵢ [symbol] of G and a subset V⊂T, to compute G_{V,H}:

| | |
|---|---|
| 1 | P [symbol] {V,T − V}, a partition of T of size 2 |
| 2 | while there are Pᵢ, Pⱼ ∈ P and an hₖ with Ø ⊂ Pᵢ^{h}^{ₖ} ∩ Pⱼ ⊂ Pⱼ and |
| | both inclusions proper |
| 3 | do P = P − {Pⱼ} ∪ {Pⱼ ∩ Pᵢ^{h}^{ₖ}, Pⱼ − Pᵢ^{h}^{ₖ}} |
| 4 | return ∩_{P}_{ᵢ}_{∈P}G_{{P}_{ᵢ}} |

Proposition 5.27 Procedure 5.26 returns G_{V,H}.

Before moving on, there are two things to note about Procedure 5.26. As we have remarked, we are essentially computing the set of points that simultaneously set stabilize V^{h} for every hεH; the problem is that we cannot intersect all of these set stabilizers directly because H may be large. But the first three steps of Procedure 5.26 are of polynomial complexity. At each iteration, the partition P is refined, so that the number of iterations is bounded by the size of the set T that is being partitioned.

Second, the intersection in the final step of the procedure should not be computed by computing all of the individual set stabilizers and then computing their intersection. Instead, recall that the set stabilizers themselves are computed using coset decomposition; if any stabilized point is moved either into or out of the set in question, the given node can be pruned. It is possible to modify the algorithm so that if any stabilized point is moved into or out of any of the sets being simultaneously stabilized, the node in question is pruned. This in fact makes line 4 faster than any of the individual set stabilizers, since the pruning condition is more general. Alternatively, we can compute and return the equivalent [Πₚ_{ᵢ}_{εP}Sym(Pᵢ)]∩G, which can be constructed with existing machinery. The groups are equal but the previous method can be expected to be faster.

This brings us to the last computational requirement in lexicographic pruning. Given a specific tεG, how can we tell if there is another t′ that will prune it?

We can prune t if there is an equivalent t′ labeling a different node with t′<t lexicographically. Note that we need to be careful that t′ label a different node, lest we prune t by virtue of a node in t's coset itself. Equivalently, if t₀ is the least element of t's subtree G_{α}t, we can prune t if there is any t′εZt with t′<t₀.

As we will see, computing t₀ is relatively straightforward, but testing if t₀ is minimal in its coset Zt₀ is not (again, as we will see shortly). It is easier to see if t₀ is minimal in its left coset t₀Z.

This turns out to be good enough. The point of the minimality test is to get one element of each coset; if zεZt, then z⁻¹εt⁻¹Z, the left coset of t⁻¹ in Z. So we can select a unique element by ensuring that t₀⁻¹ is minimal in its left coset in Z. Of course, we still have to be careful not to prune a node based on another node in the same subtree; we now have to select t₀ to be that element of t's subtree for which t₀⁻¹ is minimal. Given that t's subtree consists of all points of the form G_{α}t, we want the to for which t₀⁻¹ is the minimal element of the left coset t⁻¹G_{α}.

Definition 5.28 Let H≦G be groups, and gεG. We will denote by min(gH) the lexicographically least element of the coset gH and by is_min(g, H) the fact that g is the lexicographically least element of gH.

We have shown that we can add lexicographic pruning to our k-transporter procedure as follows:

Procedure 5.29 Given groups H≦G, an element tεG, sets c, S and U and an integer k, to find a group element g=transport (G, H, t, c, S, U, k) with gεH, c^{gt}∩S=Ø and |c^{gt}∩U|≦k:

| | |
|---|---|
| 1 | F [symbol] {α ∈c such that α is fixed by H} |
| 2 | if F^{t} ∩ S ≠ Ø |
| 3 | then return FAILURE |
| 4 | if overlap(H, c, (S ∪ U)^{t}^{^{−1}}) > k |
| 5 | then return FAILURE |
| 6 | if c ⊂ F |
| 7 | then return 1 |
| 8 | if is_min(min(t⁻¹ H), G_{{c∩F}} ∩ G_{<c-F,G}_{_{F}}_{>}) is false |
| 9 | then return FAILURE |
| 10 | α [symbol] an element of c − F |
| 11 | for each t′ in H/H_{α} |
| 12 | do r [symbol] transport(G, H_{α}, t′t, c, S, U, k) |
| 13 | if r ≠ FAILURE |
| 14 | then return rt′ |
| 15 | return FAILURE |

It remains for us to present algorithms for computing min(gH) and ismin(g, H).

Procedure 5.30 Given a group G and subgroup H≦G, along with permutations g, pεG, to compute min(g, H, p), the leticographically least element of the form ghp for hεH:

| | |
|---|---|
| 1 | if H is trivial |
| 2 | then return gp |
| 3 | T [symbol] the points that are moved by either g or H |
| 4 | sort T = {t₁,...,tₙ} |
| 5 | for i = 1,...,n |
| 6 | do α [symbol] the smallest element of tᵢ^{gHp} |
| 7 | select h such that (tᵢ^{g})^{h} = α^{p}^{^{−1}} |
| 8 | H [symbol] Hₜ_{ᵢ}_{^{g}} |
| 9 | p [symbol] hp |
| 10 | if H is trivial |
| 11 | then return gp |

Proposition 5.31 Let G be a group and H≦G a subgroup, and gεG. Then the value returned by Procedure 5.30 as min(g, H, ( )) is min(gH).

The technique for evaluating ismin is similar:

Procedure 5.32 Given a group G and subgroup H≦G, along with a gεG, to compute is_min(g, H), determining if g is the lexicographically least element of its left coset gH:

| | |
|---|---|
| 1 | if H is trivial |
| 2 | then return true |
| 3 | T [symbol] the points moved by g or H |
| 4 | sort T = {t₁,...,tₙ} |
| 5 | for i = 1,...,n |
| 6 | do if there is an h ∈ H such that tᵢ^{gh} < tᵢ^{g} |
| 7 | then return false |
| 8 | H [symbol] Hₜ_{ᵢ}_{^{g}} |
| 9 | if H is trivial |
| 10 | then return true |

Note that the check in line 6 is straightforward, since it involves simply computing the orbit of tᵢ^{g} under H.

Proposition 5.33 The value returned by Procedure 5.32 is is_min(g, H).

If we were to try to apply a similar procedure to check minimality in the right coset Hg, line 6 would involve examining all of the tᵢ^{hg} instead of the tᵢ^{gh}. The second set tᵢ^{gh} can be easily computed, since it's just the orbit of tᵢ^{g} under H, but there is no apparent method for computing tᵢ^{hg}. This is why minimality in a left coset seems easier to test than minimality in a right coset.

This is sufficient to prune the node in the lower right of FIG. 13 with which we began this section, so that the search space in our running example finally becomes as shown in FIG. 14 as desired.

It might seem that we have brought too much mathematical power to bear on the k-transporter problem specifically, but we disagree. High-performance satisfiability engines, running on difficult problems, spend in excess of 90% of their CPU time in unit propagation, which we have seen to be an instance of the k-transporter problem. Effort spent on improving the efficiency of Procedure 5.29 (and its predecessors) lead to substantial performance improvements in the ZAP embodiment described here.

While lexicographic pruning is important, it is also expensive. This is why we defer it to line 8 of Procedure 5.29. An earlier lexicographic prune would be independent of the S and U sets, but the count-based pruning is so much faster that we defer the lexicographic check to the extent possible. We will need to revisit this decision in the next section.

5.6 Watched Literals

There is one pruning technique that we have not yet considered, and that is the possibility of finding an analog in our setting to Zhang and Stickel's watched literal idea.

To understand the basic idea, suppose that we are checking to see if the clause a [symbol] b [symbol] c is unit in a situation where a and b are unvalued. It follows that the clause cannot be unit, independent of the value assigned to c.

At this point, we can watch the literals a and b; as long as they remain unvalued, the clause cannot be unit. In practice, the data structures representing a and b include a pointer to the clause in question, and the unit test needs only be performed for clauses pointed to by literals that are changing value.

Our situation is complicated by the fact that determining whether or not a clause is unit involves not a simple check, but an actual search. This introduces some ambiguity into Zhang and Stickel's idea: Is it sufficient to record simply the fact that a particular augmented clause (c, G) cannot be unit unless some literal changes value, or do we want to record the point in the search that is impacted as well?

We will return to this question shortly. For the moment, however, let us formalize the basic idea itself.

Definition 5.34 An instance of the k-transporter problem consists of a group G, together with a clause c, sets S and U, and a bound k. A solution to the instance is any gεG such that c^{g}∩S=Ø and |c^{g}∩U|≦k. The instance will be denoted (G, c, S, U, k).

A subinstance of the k-transporter problem consists of groups H≦G, together with a permutation tεG, a clause c, sets S and U, and a bound k. A solution to the subinstance is any hεH such that c^{ht}∩S=Ø and |c^{ht}∩U|≦k. The subinstance will be denoted (G, H, t, c, S, U, k).

An instance or subinstance of the k-transporter problem will be called satisfiable if and only if it has a solution.

We can now define a watching set as follows:

Definition 5.35 Let I=(G, c, S, U, k) be an instance of the k-transporter problem. A watching set for I is any set W such that (G, c, S′, U′, k) is unsatisfiable whenever S′⊃S∩W and U′⊃U∩W. Similarly, a watching set for a subinstance (G, H, t, c, S, U, k) of the k-transporter problem is any set such that (G, H, t, c, S′, U′, k) is unsatisfiable whenever S′⊃S∩W and U′⊃U∩W.

Proposition 5.36 Every unsatisfiable instance or subinstance of the k-transporter problem has a watching set.

Zhang and Stickel treat satisfied and unvalued literals equally, instead of drawing the distinction between them that we do. They do this because (1) Given that no search is involved in their unit test, finding a second literal to add to a watching set is inexpensive, and (2) Most satisfied literals will eventually become unvalued as the search proceeds; by treating satisfied and unvalued literals identically, no adjustments need be made when the search backs up and a literal becomes unvalued.

Definition 5.37 Let I=(G, c, S, U, k) be an instance of the k-transporter problem. A condensed watching set for I is any set W such that (G, c, S′, U′, k) is unsatisfiable whenever U′⊃U∩W. Similarly, a condensed watching set for a subinstance (G, H, t, c, S, U, k) of the k-transporter problem is any set such that (G, H, t, c, S′, U′, k) is unsatisfiable whenever U′⊃U∩W.

Proposition 5.38 A set W is a condensed watching set for (G, c, S, U, k) if and only if (G, c, S′, U′, k) is unsatisfiable whenever S′∪U′⊃U∩W. W is a condensed watching set for (G, H, t, c, S, U, k) if and only if (G, H, t, c, S′, U′, k) is unsatisfiable whenever S′∩U′⊃U∩W.

In other words, the definition of condensed watching sets allows us to think of satisfied and unvalued literals (in S and U respectively) as one.

To see that our notion generalizes the earlier one, consider the following results:

Proposition 5.39 Suppose I=(1, c, S, U, k) is an instance of the k-transporter problem. Then W is a watching set for I if and only if |W∩c∩S|>0 or |W∩c∩U|>k. W is a condensed watching set for I if and only if |W∩c∩(S∪U)|>k.

Taking k=1 obviously generalizes the existing notion.

Proposition 5.40 Given a cardinality constraint c requiring at least m of the associated literals to be true, W is a condensed watching set for c if and only if it includes at least m+1 literals in c.

A cardinality constraint x₁+ . . . +xₙ≧m is equivalent to the augmented clause
(x₁ [symbol] . . . [symbol] xₙ₋ₘ₊₁,Sym(xᵢ))
and Proposition 5.40 is now generalized by:

Proposition 5.41 Suppose I=(Sym(c′), c, S, U, k) is an instance of the k-transporter problem where c⊂c′. Then W is a watching set for I if either |W∩c′∩S|>|c′−c| or |W∩c′∩(S∪U)|>k+|c′−c|. W is a condensed watching set for I if and only if |W∩c′∩(S∩U)|>k+|c′−c|.

To see that this generalizes Proposition 5.40, note that for a cardinality constraint as in Proposition 5.40, we will have xₙ₋ₘ₊₂, . . . , xₙ in c′−c, so that |c′−c′=m−1. Taking k=1 in the conclusion of Proposition 5.41 allows us to conclude that W is a condensed watching set if and only if |W∩c′∩(S∪U)>m. In other words, W is a condensed watching set if it includes at least m+1 satisfied or unvalued literals in the original cardinality constraint.

Having considered these examples, we now return to the general construction. As we've remarked, the basic use for watching sets is to reduce the frequency with which clauses (augmented or not) must be examined to see if they have unit instances.

To understand some of the difficulties involved, consider the augmented clause corresponding to the quantified clause
∀xy.p(x) [symbol] q(y)→r

If P is the set of instances of p(x) and Q the set of instances of q(y), this becomes the augmented clause
( [symbol] p(0) [symbol] / [symbol] q(0) [symbol] r,Sym(P)×Sym(Q)) (23)
where p(0) and q(0) are elements of P and Q respectively.

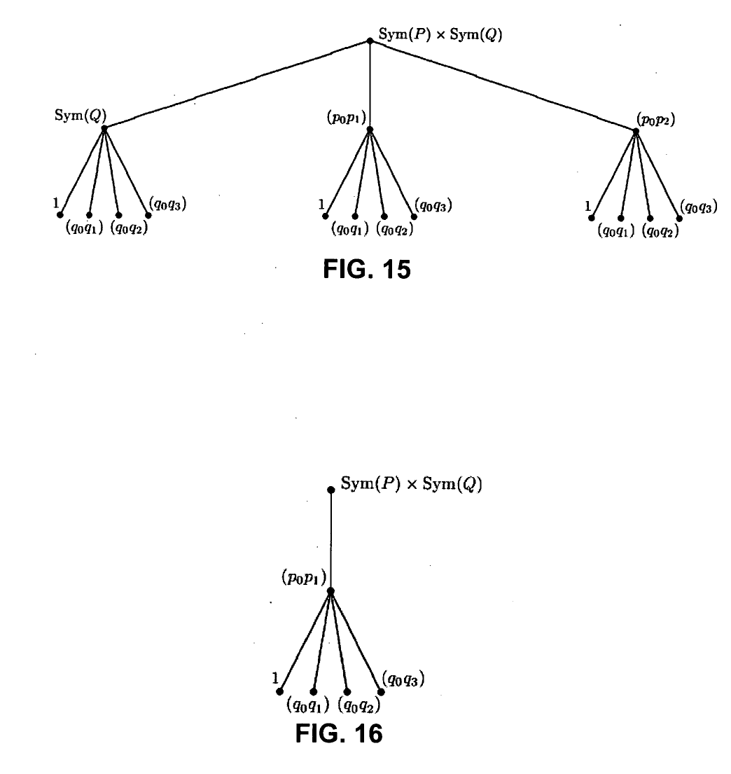

Now suppose that q(y) is true for all y, but p(x) is unvalued, as is r. Suppose also that we search for unit instances of (23) by first stabilizing the image of q and then of p (r is stabilized by the group Sym(P)×Sym(Q) itself). If there are four possible bindings for y (which we will denote 0, 1, 2, 3) and three for x (0, 1, 2), the search space is as shown in FIG. 15. In the interests of conserving space, we have written pᵢ instead of p(i) and similarly for qⱼ.

Each of the fringe nodes fails because both r and the relevant instance of p(x) are unvalued. As we work to understand watched literals in this broader setting, the questions that we need to answer are the following:
1. When a node fails because certain literals are satisfied or unvalued, what information should be passed back from the search?
2. How is this information used to reduce the amount of search that must be performed when one of the literals in question changes value later?

One approach would have us pass out only the literals that caused the failure, but (as we remarked earlier), this may cause us to lose significant amounts of information regarding portions of the search space that need not be reexamined. Perhaps it would make more sense to pass back not only the literals in question, but a description of the node itself, presumably by passing out the permutation t connecting the given node to the root.

In this example, the responsible literals at each fringe node are as shown in FIG. 16. If we simply accumulate these literals at the root of the search tree, we conclude that the reason for the failure is the watching set {p₀, p₁, p₂, r} (which is indeed a watching set for this problem instance). The difficulty is that if any of these watched literals changes value, we potentially have to reexamine the entire search tree.

We could, on the other hand, compute not a watching set for the instance corresponding to the entire tree, but a watching set for the stubinstance corresponding to the node that actually fails. So the information accumulated from the tree in this example would actually be:

$$\{ \begin{matrix}( \{ {p}_{0} , r \} , 1 ) , & ( \{ {p}_{1} , r \} , ( {p}_{0} {p}_{1} ) ) , & ( \{ {p}_{2} , r \} , ( {p}_{0} {p}_{2} ) ) , \\ ( \{ {p}_{0} , r \} , ( {q}_{0} {q}_{1} ) ) , & ( \{ {p}_{1} , r \} , ( {p}_{0} {p}_{1} ) ( {q}_{0} {q}_{1} ) ) , & ( \{ {p}_{2} , r \} , ( {p}_{0} {p}_{2} ) ( {q}_{0} {q}_{1} ) ) , \\ ( \{ {p}_{0} , r \} , ( {q}_{0} {q}_{2} ) ) , & ( \{ {p}_{1} , r \} , ( {p}_{0} {p}_{1} ) ( {q}_{0} {q}_{2} ) ) , & ( \{ {p}_{2} , r \} , ( {p}_{0} {p}_{2} ) ( {q}_{0} {q}_{2} ) )\end{matrix} \}$$

Each entry consists of a set of variables and the permutation leading to the node that will need to be reevaluated if one of the variables changes value. Now when some individual pᵢ changes value, we only need to reexamine three nodes, as opposed to the entire search space.

It is our belief that both of these approaches are wrong. If the search tree for this problem is to be reevaluated because the value of p₁ has changed, we should not be using a variable ordering for which the four appearances of p₁ remain separate. Instead, we should first reorder the variables chosen for stabilization, replacing the search space depicted above with the space illustrated in FIG. 17.

Now only the center node needs reexpansion, since it is only at this node that the modified literal p₁ appears. The search space becomes simply the one shown in FIG. 18, which is what one would expect if p₁ changes value.

What we are suggesting, then, is that the answers to the questions we posed previously be as follows:
1. When a node fails because certain literals are satisfied or unvalued, what information should be passed back from the search? All that is required is a watching set—a list of literals that led to the failure.
2. How is this information used to reduce the amount of search that must be performed when one of the literals in question changes value later? When the search is reconsidered because a watched literal has changed value, we first stabilize clause elements that can be mapped to the literal in question, and we prune any node that cannot be impacted by the changed literal.

If we modify the procedures developed thus far to incorporate this change, the results as follows:

Procedure 5.42 Given groups H≦G, an element tεG, sets c, S and U, an integer k, and optionally a watched element w, to find a group element g=transport (G, H, t, c, S, U, k, w) with gεH, c^{gt}∩S=Ø, |c^{gt}∩U|≦k, and wεc^{gt} if w is supplied:

| | |
|---|---|
| 1 | F [symbol] {α ∈ c such that α is fixed by H} |
| 2 | if w is supplied and w ∉ F^{t} and w^{t}^{^{−1}} ∉ c^{H} |
| 3 | then return <FAILURE, Ø> |
| 4 | if F^{t} ∩ S ≠ Ø |
| 5 | then return <FAILURE, s> for any s ∈ F^{t} ∩ S |
| 6 | V [symbol] overlap(H, c, (S ∪ U)^{t}^{^{−1}}, k) |
| 7 | if V ≠ Ø |
| 8 | then return <FAILURE, V> |
| 9 | if c ⊂ F |
| 10 | then return <success, 1> |
| 11 | if is_min(min(t⁻¹H), G_{{c∩F}} ∩ G<c−F,G_{_{F}}_{>}) is false |
| 12 | then return <FAILURE, Ø> |
| 13 | α [symbol] an element of c − F. If w is supplied and |
| | w ∉ F^{t}, choose α so that w ^{t}^{^{−1}}∉ α^{H}. |
| 14 | W [symbol] Ø |
| 15 | for each t′ in H/H_{α} |
| 16 | do <r, w> [symbol] transport (G, H_{α}, t′t, c, S, U, k, w) |
| 17 | if r = SUCCESS |
| 18 | then return <SUCCESS, wt′> |
| 19 | else W [symbol] W ∪ w |
| 20 | return <FAILURE, W> |

The pervasive change is that transport now returns two values, a success or failure marker and then either a watching set (if failure) or the usual group element if success. There are the following cases:
1. If the desired watched literal w cannot be in the image c^{gt}, we fail immediately without watching anything. To see if wεc^{gt} for some g, we check to see if either w is already in the fixed portion of the image F^{t}, or if w^{t}^{^{−1}}εc^{g} for some g. This last condition is equivalent to the requirement that w^{t}^{^{−1}} be in c^{H}, the orbit of c under H.
2. If the clause is mapped into the set S, we can prune immediately. We need to record any disallowed element s to which the clause is mapped as the watching set; as long as sεS, the node will continue to fail.
3. If the clause will overlap U by more than k, we return the reason for the eventual overlap, which is now computed by the overlap function. We have modified overlap to accept as an additional argument a limit for the allowed overlap.
4. If the procedure succeeds because the entire clause has been mapped (line 9), we return the permutation as usual.
5. If this node is pruned for lexicographic reasons (line 11), we also do not need to return a watching set. The node will always be pruned independent of the values of S and U, since the lexicographic condition does not depend on S or on U.
6. If the recursive call succeeds (line 17), we return the permutation computed.
7. If the recursive call fails (line 19), we combine the watching set for the node expanded with the watching set being accumulated from that node's siblings.
8. If all the siblings fail, we return the accumulated watching set.

Another change is in line 13, where we choose the point to stabilize so that the watched literal w is in its image (unless we have already stabilized such a point). This is guaranteed to be possible because we know from line 2 that w^{t}^{^{−1}}εc^{H}.

Note the difference between the lexicographic prune on line 11 and the prunes that may precede it; it is only the lexicographic prune that does not need to increase the size of the watching set. Given this, it might seem that the lexicographic test should precede the others in the implementation.

This appears not to be the case. As we have remarked, the lexicographic test is the most expensive of those presented; moving it earlier (to precede line 4, presumably) actually slows the unit propagation procedure by approximately 14%, primarily due to the reduction in times for certain satisfiable outliers where the lexicographic, test would otherwise be called many times. In addition, the absolute impact on the watching sets can be expected to be quite small.

To understand why, suppose that we are executing the procedure for an instance where it will eventually fail. Now if n is a node that can be pruned either by a counting argument (with the new contribution Wₙ to the set of watched literals) or by a lexicographic argument using another node n′, then since the node n′ will eventually fail, it will contribute its own watching set W_{n′}, to the eventually returned value. While it is possible that Wₙ≠W_{n′} (different elements of F^{t}∩S may be selected in line 5, for example), we expect that in the vast majority of cases we will have Wₙ=W_{n′} and the non-lexicographic prune will have no impact on the eventual watching set computed.

Procedure 5.43 Given a group H, two sets c, V acted on by H, and a bound k≧0 to compute overlap(H, c, V, k), a collection of elements of V sufficient to guarantee that for any hεH, |c^{h}∩V|>k, or Ø if no such collection exists:

| | |
|---|---|
| 1 | m [symbol] 0 |
| 2 | W [symbol] Ø |
| 3 | for each orbit X of H |
| 4 | do {Bᵢ} [symbol] a minimal block system for X |
| | under H for which c ⊂ Bᵢ for some i |
| 5 | Δ = \|c\| + min(Bᵢ ∩ V) − \|B₁\| |
| 6 | if Δ > 0 |
| 7 | then m [symbol] m + Δ |
| 8 | W [symbol] W ∪ (X ∩ V) |
| 9 | if m > k |
| 10 | then return W |
| 11 | return Ø |

Here, we simply accumulate the watched literals from each orbit; if there is no contribution to m, we don't need to watch anything. This procedure could (and should) be adjusted slightly to reduce W if there is some excess in that m>k+1 on line 9. Of course, we can return the given watching set as soon as the size of the overlap exceeds the allowed cutoff.

If the overlap remains sufficiently small, we return Ø to indicate that no prune is possible. Note that since the transport procedure guarantees that k≧0, we will never generate a prune without adding something to the set W in line 8 of the overlap procedure.

The min, is_min and transparency procedures are unchanged from the previous versions.

6 ZAP Problem Format

Historically, Boolean satisfiability problems are typically in a format where variables correspond to positive integers, literals are nonzero integers (negative integers are negated literals), and clauses are terminated with zeroes. The so-called DIMACS format precedes the actual clauses in the problem with a single line such as p cnf 220 1122 indicating that there are 220 variables appearing in 1,122 clauses in this problem. The problems in the Velev suite, for example, conform to this format.

The numerical format described here makes it impossible to exploit any existing understanding that the user might have of the problem in question; this may not be a problem for a conventional Boolean tool (since the problem structure will have been obscured by the Boolean encoding in any event), but was felt to be inappropriate when building an augmented solver. We felt that it was important for the user to be able to:
1. Specify numerical constraints such as appear in cardinality or parity constraints,
2. Quantify axioms over finite domains, and
3. Provide group augmentations explicitly if the above mechanisms were insufficient.

Let us describe the provisions made in each of these areas.

Cardinality and parity constraints The general form of a ZAP axiom is
quantifiers symbols result
   where the quantifiers are described in the next section and the symbols are essentially a sequence of literals. The result includes information about the desired “right hand side” of the axiom, and can be any of the following:
A simple terminator, indicating that the clause is Boolean,
A comparison operator (>, <=, =, etc.) followed by an integer, indicating that the clause is a cardinality constraint, or
A modular arithmetic operator (% n=) followed by an integer m, indicating that the sum of the values of the literals is required to be congruent to m mod n.

Quantification In order for quantification to be used successfully, ZAP needs to be able to work with predicate symbols. Each ZAP input file therefore begins with a list of domain specifications, giving the names and sizes of each domain used in the theory. This is followed with predicate specifications, giving the arity of each predicate and the domain type of each argument. After the predicates and domains have been defined, it is possible to refer to predicate instances directly (e.g., in[1 3] indicating that the first pigeon is in the third hole) or in an unground fashion (e.g., in[x y]).

The quantifiers are of the form
∀(x₁, . . . ,xₖ)
or
∃(x₁, . . . ,xₖ)
where each of the xᵢ are variables that can then appear in future predicate instances. In addition to the two classical quantifiers above, we also introduce
\overline{∀}(x₁, . . . ,xₖ)
where the \overline{∀} quantifier means that the variables can take any values that do not cause any of the quantified predicate's instances to become identical. As an example, the axiom saying that only one pigeon can be in each hole now becomes simply
\overline{∀}(p₁,p₂)∀h. [symbol] in(p₁,h) [symbol] [symbol] in(p₂,h)
or even
\overline{∀}(p₁,p₂,h). [symbol] in(p₁,h) [symbol] [symbol] in(p₂,h)

The introduction of the new quantifier should be understood in the light of our earlier discussion where we argued that in many cases, the quantification given by \overline{∀} is in fact more natural than that provided by ∀. The \overline{∀} quantification is also far easier to represent using augmented clauses, and avoids in many cases the need to introduce or to reason about equality. In any event, ZAP supports both forms of universal quantification.

Group definition Finally, the user can specify a group directly, assigning it a symbolic designator that can then be used in an augmented clause. The syntax is the conventional one, with a group being described in terms of generators, each of which is a permutation. Each permutation is a list of cycles, and each cycle is a comma-separated list of literals.

It will be understood that a reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A method for searching a database for data satisfying a property specified by a query, the database containing data within an application domain and encoded in a group theory representation, comprising:
formulating the query in terms of the group theory representation;
executing the query on the data in the database within the application domain and encoded in the group theory representation to identify zero or more database elements and group elements in the group theory representation satisfying the query; and
outputting the zero or more database elements and group elements satisfying the query.

2. The method of claim 1, wherein the data within the application domain are represented as one or more augmented clauses, where each augmented clause has a pair (c,G) including a database element c and an associated group G of group elements g acting on c.

3. The method of claim 2, wherein the group elements g are permutations.

4. The method of claim 2, wherein the query is of a type “find an element x that satisfies a property P” and wherein formulating the query in terms of the group theory representation comprises:
formulating the query as a type “find database element c and element g of the associated group G, such that g(c) satisfies property P.”

5. The method of claim 1, wherein outputting the zero or more database elements and group elements satisfying the query comprises:
converting the zero or more database elements and group elements satisfying the query from the group theory representation to a native representation of the data within the application domain; and
outputting the zero or more converted database elements satisfying the query.

6. The method of claim 5, wherein a database element satisfying the query includes a database element c and a group element g of an associated group G, wherein the converting comprises:
constructing g(c) to produce the database element in its native representation.

7. The method of claim 1, wherein the query comprises a high-level query, the method further comprising:
generating one or more low-level queries from the high-level query, wherein the formulating step formulates the low-level queries in the group theory representation and wherein the executing step executes the low-level queries on the data in the database.

8. The method of claim 7, the method further comprising:
generating one or more additional low-level queries responsive to one or more results of one or more previously-executed low-level queries, wherein the formulating step formulates the one or more additional low-level queries in the group theory representation and wherein the executing step executes the one or more additional low-level queries on the data in the database.

9. The method of claim 1, further comprising:
representing the zero or more database elements and group elements satisfying the query as a subgroup, wherein some elements are described explicitly and remaining elements are described in terms of the explicitly described group elements.

10. The method of claim 1, wherein the data within the application domain describe a digital logical device and wherein the query performs a verification and/or test of the device.

11. A system for using group theory to manipulate data in a database, comprising:
a query execution module for executing a query on the data in the database, wherein the data in the database are within an application domain and are encoded in a group theory representation and wherein the query specifies a search for database elements and group elements satisfying a property specified by the query.

12. The system of claim 11, further comprising:
a database construction module for receiving input data within the application domain in a native representation and for encoding the input data in a group theory representation.

13. The system of claim 12, wherein the input data in the group theory representation include one or more augmented clauses, where each augmented clause has a pair (c,G) including a database element c and a group G of group elements g acting on c.

14. The system of claim 13, wherein the group elements g are permutations.

15. The system of claim 13, further comprising:
a query formation module for receiving an input query, the input query specifying a search for database elements satisfying a property in a native representation of the data, and for converting the input query into a search for equivalent database elements and associated group elements in the group theory representation of the data.

16. The system of claim 15, wherein the input query is of a type “find an element x that satisfies property P” and wherein the converted input query is of a type “find database element c and element g of an associated group G, such that g(c) satisfies property P.”

17. The system of claim 11, wherein the query execution module identifies zero or more database elements and group elements satisfying the query and further comprising:
a result construction module for converting the zero or more database elements and group elements satisfying the query from the group theory representation to a native representation of the data within the application domain.

18. The system of claim 17, wherein a database element satisfying the query includes a database element c and a group element g of an associated group G, and wherein the result construction module constructs g(c) to produce the database element in its native representation.

19. The system of claim 11, further comprising:
a query formation module for receiving a high-level input query, and for generating one or more low-level queries responsive to the high-level input query, the one or more low-level queries specifying searches for database elements and group elements in the group theory representation of the data.

20. The system of claim 19, wherein the query formation module is further adapted to generate one or more additional low-level queries in response to one or more results of one or more previously-executed low level queries.

21. The system of claim 11, wherein the query execution module identifies zero or more database elements and group elements satisfying the query and further comprising:
a result construction module for representing the zero or more database elements and group elements satisfying the query as a subgroup, wherein some elements are described explicitly and remaining elements are described in terms of the explicitly described group elements.

22. The system of claim 11, wherein the data within the application domain describe a digital logical device and wherein the query performs a verification and/or test of the device.

23. A computer program product comprising:
a computer-readable medium having computer program code embodied therein for encoded thereon computer program modules for using group theory to manipulate data in a database, the computer program modules comprising:
a query execution module for executing a query on the data in the database, wherein the data in the database are within an application domain and are encoded in a group theory representation and wherein the query specifies a search for database elements and group elements satisfying a property specified by the query.

24. The computer program product of claim 23, the computer program modules further comprising:
a database construction module for receiving input data within the application domain in a native representation and for encoding the input data in a group theory representation.

25. The computer program product of claim 24, wherein the input data in the group theory representation include one or more augmented clauses, where each augmented clause has a pair (c,G) including a database element c and a group G of group elements g acting on c.

26. The computer program product of claim 25, wherein the group elements g are permutations.

27. The computer program product of claim 25, the computer program modules further comprising:
a query formation module for receiving an input query, the input query specifying a search for database elements satisfying a property in a native representation of the data, and for converting the input query into a search for equivalent database elements and associated group elements in the group theory representation of the data.

28. The computer program product of claim 27, wherein the input query is of a type “find an element x that satisfies property P” and wherein the converted input query is of a type “find database element c and element g of an associated group G, such that g(c) satisfies property P.”

29. The computer program product of claim 23, wherein the query execution module identifies zero or more database elements and group elements satisfying the query, the computer program modules further comprising:
a result construction module for converting the zero or more database elements and group elements satisfying the query from the group theory representation to a native representation of the data within the application domain.

30. The computer program product of claim 29, wherein a database element satisfying the query includes a database element c and a group element g of an associated group G, and wherein the result construction module constructs g(c) to produce the database element in its native representation.

31. The computer program product of claim 23, the computer program modules further comprising:
a query formation module for receiving a high-level input query, and for generating one or more low-level queries responsive to the high-level input query, the one or more low level queries specifying searches for database elements in the group theory representation of the data.

32. The computer program product of claim 31, wherein the query formation module is further adapted to generate one or more additional low-level queries in response to one or more results of one or more previously-executed low-level queries.

33. The computer program product of claim 23, wherein the query execution module identifies zero or more database elements and group elements satisfying the query and further comprising:
a result construction module for representing the zero or more database elements and group elements satisfying the query as a subgroup, wherein some elements are described explicitly and remaining, elements are described in terms of the explicitly described group elements.

34. The computer program product of claim 23, wherein the data in the application domain describe a digital logical device and wherein the query performs a verification and/or test of the device.
